(19) United States
(12) Patent Application Publication
(10) Pub. No.: US 2023/0148641 A1
(43) Pub. Date: May 18, 2023

(54) FLAVOR COMPOSITION

(71) Applicant: Firmenich SA, Satigny (CH)

(72) Inventors: Maryline BILLAT-ROSSI, Satigny (CH); Brigitte PELLEN, Grasse (FR); Sylvain LAUVAUX, Louvain-La-Neuve (BE)

(21) Appl. No.: 17/907,667

(22) PCT Filed: Mar. 29, 2021
(86) PCT No.: PCT/EP2021/058192

§ 371 Date: Sep. 28, 2022

(30) Foreign Application Priority Data
Mar. 31, 2020 (WO) 20167276.3

(51) Int. Cl. A23L 27/20; A23L 27/26; A23L 27/29; A23L 27/00; A23L 27/30

(52) U.S. Cl. CPC A23L 27/204; A23L 27/206; A23L 27/26; A23L 27/29; A23L 27/84; A23L 27/86; A23L 27/88; A23L 27/30

(57) ABSTRACT

The present invention relates to the field of flavor. More particularly, it concerns a flavor composition comprising 2-hydroxy-4-methoxybenzaldehyde and a flavored consumer product comprising the invention's composition. Moreover, the present invention concerns a method to confer, enhance, improve or modify the flavor properties of a flavored article and a method to reduce, limit, inhibit or suppress off-flavor in flavored article which methods comprise adding to said article an effective amount of composition as defined above.

### TECHNICAL FIELD

The present invention relates to the field of flavor. More particularly, it concerns a flavor composition comprising 2-hydroxy-4-methoxybenzaldehyde and a flavored consumer product comprising the invention's composition. Moreover, the present invention concerns a method to confer, enhance, improve or modify the flavor properties of a flavored article and a method to reduce, limit, inhibit or suppress off-flavor in a flavored article which methods comprise adding to said article an effective amount of composition as defined above.

### BACKGROUND OF THE INVENTION

The flavor industry is permanently seeking new organoleptic notes and to build novel accords in order to mimic nature which provides very complex flavors with a multitude of facets. Some of the most sought ingredients in the flavor industry are the ones, imparting to a flavor composition, fullness/roundness while also improving the long lastingness or the complexity of the aroma.

Therefore, there is still a need to provide a composition allowing to boost or to enhance the roundness and especially in compositions used, particularly, in sweet, beverage and savory consumer products.

The present invention addresses these needs by providing a flavoring composition comprising 2-hydroxy-4-methoxybenzaldehyde and at least one or more ingredients capable of imparting a characteristic flavor note associated with phenolic note, dairy and meaty notes, brown flavors note, honey and botanicals notes, fruits note and alcoholic beverages note; and/or at least one ingredient selected from the list of sweetener or taste modulator.

### SUMMARY OF THE INVENTION

The invention relates to a flavor composition particularly appreciated for its roundness and long lastingness.

So a first object of the present invention is a flavor composition comprising
i) 2-hydroxy-4-methoxybenzaldehyde; and
ii) At least one or more ingredients capable of imparting a characteristic flavor note associated with
   a. phenolic note;
   b. dairy and meaty notes;
   c. brown flavors note;
   d. honey and botanicals notes;
   e. fruits note,
   f. alcoholic beverages note;

and/or
iii) at least one ingredient selected from the list of sweetener, trigeminal sensates or taste modulator.

A second object of the present invention is a flavored consumer product comprising a composition as defined above.

A third object of the present invention is a method to confer, enhance, improve or modify the flavor properties of a flavored article, which method comprises adding to said article an effective amount of composition as defined above.

A further object of the present invention is a method to reduce, limit, inhibit or suppress off-flavor of a protein-based foodstuffs, vegetable drinks, imitation dairies, cereal products or non-alcoholic beverages which method comprises adding to said article an effective amount of composition as defined above.

### DESCRIPTION OF THE INVENTION

Unless stated otherwise, percentages (%) or ppm are meant to designate a percentage by weight of a composition.

Surprisingly, it has now been discovered that 2-hydroxy-4-methoxybenzaldehyde provides to a flavoring composition imparting phenolic note, dairy and meaty notes, brown flavors note, honey and botanicals notes, fruits note or alcoholic beverages note a fullness particulars sought by flavorist. In addition, the invention's flavor composition possesses phenolic connotation, without necessary the presence of vanillin, while boosting smoky and maturation notes, in particular, in alcoholic beverages.

So, a first object of the present invention is a flavor composition comprising
i) 2-hydroxy-4-methoxybenzaldehyde; and
ii) At least one or more ingredients capable of imparting a characteristic flavor note associated with
   a. phenolic note;
   b. dairy and meaty notes;
   c. brown flavors note;
   d. honey and botanicals notes;
   e. fruits note,
   f. alcoholic beverages note;

and/or
iii) at least one ingredient selected from the list of sweetener, trigeminal sensates or taste modulator.

The invention's composition may be in the form of a food matrix, food substance or other edible product. 2-hydroxy-4-methoxybenzaldehyde may be obtained by extraction, natural process, synthetic process or combination of natural and synthetic process starting from natural or synthetic sources/starting materials. By natural process, it is meant plant microbiology process, fermentation, microbiological process or enzymatic process.

According to a particular embodiment, 2-hydroxy-4-methoxybenzaldehyde may be obtained by extraction from Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus or other related botanical species known or expected to contain 2-hydroxy-4-methoxybenzaldehyde. Preferably, the botanical source may be Periploca sepium, Periploca angustifolia, Periploca laevigata, Decalepis hamiltonii, Hemidesmus indicus or Mondia whitei. Even more preferably, the botanical source may be Periploca sepium. 2-hydroxy-4-methoxybenzaldehyde may be used as a pure compound or may be part of a complex mixture such as an extract. According to a particular embodiment, 2-hydroxy-4-methoxybenzaldehyde is part of a Periploca sepium extract and/or Decalepis hamiltonii extract.

According to a particular embodiment, 2-hydroxy-4-methoxybenzaldehyde is in the form of a extract from a natural source. Said extract comprises at least 10%, 20%, 30%, 40%, 50%, 60%, 70%, 80%, 90%, 95% or 99% of 2-hydroxy-4-methoxybenzaldehyde. Said extract comprises at most 500 ppm of 3-hydroxy-4-methoxybenzaldehyde. Preferably, said extract may comprise at most 250 ppm, 100 ppm, 80 ppm or 50 ppm of 3-hydroxy-4-methoxybenzaldehyde. The natural source of 2-hydroxy-4-methoxybenzaldehyde is Biondia hemsleyana, Periploca graeca, Periploca sepium, Periploca angustifolia, Periploca laevigata, Stelmocrypton khasianum, Tylophora indica, Decalepis hamiltonii, Decalepis arayalpathra, Hemidesmus indicus, Mondia whitei, Tarenna attenuata, Periploca genus. Preferably, the natural source may be Periploca sepium, Periploca angustifolia, Periploca laevigata, Decalepis hamiltonii, Hemidesmus indicus or Mondia whitei. Even more preferably, the natural source may be Periploca sepium.

According to any embodiments of the present invention, the invention's flavor composition comprises less than 0.5%, even less than 0.1% of 2-hydroxy-4-methoxybenzaldehyde, even less than 0.05% of 2-hydroxy-4-methoxybenzaldehyde.

The concentration of 2-hydroxy-4-methoxybenzaldehyde is in the range of from 0.00001 to 50 ppm ready-to-consume (RTC), preferably in a range from 0.00001 to 0.1 ppm, preferably in a range from 0.00001 to 0.03 ppm. According to a particular embodiment, the concentration of 2-hydroxy-4-methoxybenzaldehyde is in the range of from 0.0001 to 50 ppm, preferably in a range from 0.0005 to 20 ppm, preferably in a range from 0.0005 to 10 ppm, preferably in a range from 0.005 to 1 ppm, preferably in a range from 0.005 to 0.2 ppm, even more preferably in a range from 0.01 to 0.5 ppm.

By the expression “ingredients capable of imparting a characteristic flavor note associated with . . . ” or similar, it is meant here ingredients recognized as flavoring ingredient, i.e. used in flavoring preparations or compositions to impart a hedonic effect.

In other words, such ingredients, to be considered as being a flavoring one, must be recognized by a person skilled in the art as being able to impart or modify in a positive or pleasant way the taste of a composition, and not just as having a taste.

By “phenolic note”, it is meant the normal meaning understood by a person skilled in the art, i.e. ingredients imparting vanilla flavor, or any facet of the vanilla flavor and/or smoky note and/or roasted and/or woody note. Particularly, phenolic not are understood as smoky note and/or woody note.

A non-limiting list of suitable ingredients capable of imparting a characteristic flavor note associated with phenolic note may be selected from the group consisting of phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 4-ethenylphenol, 2-ethoxy-5-(1-propenyl)phenol, 4-methoxybenzaldehyde, 4-methoxy-benzenemethanol, 4-methoxy-benzoic acid, 1,3-benzodioxole-5-carbaldehyde, 4-methoxybenzyl acetate, (4-methoxyphenyl) methyl formate, methyl 2-hydroxy-4-methoxybenzoate, 4-hydroxy-benzenemethanol, 2,6-dimethoxy-phenol, 4-hydroxy-3-methoxybenzyl alcohol, 4-hydroxy-3-methoxybenzyl acetate, 4-hydroxy-3-methoxybenzyl acid, 4-(ethoxymethyl)-2-methoxyphenol, (E)-1-(4-methoxy-1-phenyl)-1-penten-3-one, 2-methyl-phenol, 1,2-dimethoxy-4-methylbenzene, vanilla extract, benzoin extract, peru balsam extract, tolu extract, guaiacwood oil, 3,4-dimethoxy-benzaldehyde, 3-ethoxy-4-hydroxybenzaldehyde, 4-(4-methoxyphenyl)-2-butanone, 3-hydroxy-2-methoxybenzaldehyde, 3-hydroxy-5-methoxybenzaldehyde, 2-hydroxy-3-methoxybenzaldehyde, 2-hydroxy-5-methoxybenzaldehyde, 3-hydroxy-4-methoxybenzaldehyde, 4-hydroxy-2-methoxy-benzaldehyde, 2,4-dimethoxy-benzaldehyde, 2,4-diethoxy-benzaldehyde, 2,4-dimethoxy-6-methyl-benzaldehyde, 5-ethoxy-2-hydroxy-benzaldehyde, 5-hydroxy-2-methoxy-benzaldehyde, 2,6-dimethoxy-4-methylbenzaldehyde, 2-methoxy-4-(methoxymethyl)phenol, 4-(methoxymethyl)phenol, 4-hydroxybenzaldehyde, 4-methoxy-methyl ester benzoic acid, 4-hydroxybenzoic acid, methyl 4-hydroxy-3-methoxybenzoate, ethyl 4-hydroxy-3-methoxybenzoate, 4-hydroxy-3-methoxybenzoic acid, 4-hydroxy-3,5-dimethoxy-benzaldehyde, ethyl ester 4-methoxy benzoic acid, 2-methyl-1-(p-tolyl)butane-1,3-dione, 6-(4-methoxyphenyl)-3-methylhexane-2,4-dione, lactoyl vanillin, lactoyl isovanillin, lactoyl p-hydroxybenzaldehyde, lactoyl p-hydroxy-m-methoxycinnamic acid, lactoyl isovanillin acid, oleyl vanillin, decanoyl vanillin, divanillyl succinate, lactoyl eugenol, gluconyl vanillin and a combination thereof. Particularly, the ingredients capable of imparting characteristic flavor note associated with phenolic note may be selected from the group of phenol, 2-methoxyphenol, 2-methoxy-4-vinyl-phenol, 2-methoxy-4-(1-propen-1-yl)phenol, 2-methoxy-4-methyl-phenol, 4-methoxybenzaldehyde, 4-methoxy-benzenemethanol, 1,3-benzodioxole-5-carbaldehyde, 4-methoxybenzyl acetate, 4-hydroxy-3-methoxybenzyl acetate, 4-hydroxy-3-methoxybenzyl acid, vanilla extract, benzoin extract, peru balsam extract, tolu extract, guaiacwood oil and a combination thereof. Even more particularly, the ingredients capable of imparting characteristic flavor note associated with phenolic note may be selected from the group of phenol, 2-methoxyphenol, 2-methoxy-4-vinyl-phenol, 4-methoxybenzaldehyde, 4-methoxy-benzenemethanol, 1,3-benzodioxole-5-carbaldehyde, vanilla extract, benzoin extract, peru balsam extract and a combination thereof.

According to any embodiments of the present invention, the flavor composition comprises at least one, two, three, four, five, six, seven, eight, nine, ten or even more ingredients capable of imparting characteristic flavor note associated with phenolic note.

The concentration of ingredients capable of imparting a characteristic flavor note associated with phenolic note is in the range of from 0.0001 to 10000 ppm ready-to-consume (RTC), preferably in a range from 0.0005 to 20 ppm, preferably in a range from 0.0005 to 10 ppm, preferably in a range from 0.0005 to 5 ppm, preferably in a range from 0.0005 to 2 ppm, preferably in a range from 0.01 to 5 ppm, even more preferably in a range from 0.01 to 2 ppm. 2-hydroxy-4-methoxybenzaldehyde may be used in combination with such ingredients capable of imparting characteristic flavor note associated with phenolic note in any suitable ratio (w/w) ranging from 1:1000000 to 1000:1, or from 1:100000 to 500:1, or from, 1:10000 to 200:1, or from 1:1000 to 100:1, or from 1:50 to 10:1, or from 1:100 to 50:1.

By “dairy and meaty notes”, it is meant the normal meaning understood by a person skilled in the art, i.e. ingredients imparting dairy flavor such as butter, cream, milk or yogurt, meaty flavor such as bovine, ovine, poultry or pork notes with any cooked or smoked connotation, or any facet associated with said flavors.

A non-limiting list of suitable ingredients capable of imparting a characteristic flavor note associated with dairy and meaty notes may be selected from the group consisting of decanoic acid, butanoic acid, 2-methylpropanoic acid, 6-heptyltetrahydro-2H-pyran-2-one, 3-hydroxy-2-butanone, 2,3-pentanedione, 5-pentylfuran-2(5H)-one, tetrahydro-6-pentyl-2H-pyran-2-one, 6-heptyltetrahydro-2H-pyran-2-one, dihydro-2(3H)-furanone, 3-methyl-butanoic acid, decenoic acid, dodecanoic acid, tetradecanoic acid, hexadecanoic acid, octadecanoic acid, (Z)-9-octadecenoic acid, 2-decanone, 2-heptanone, 3-heptanone, ethyl lactate, acid octanoic, dairy extracts and processed dairy products, 2-methyl-3-furanthiol, bis(2-methyl-3-furyl)disulfide, (E)-2-nonenal and a combination thereof. Particularly, the ingredients capable of imparting a characteristic flavor note associated with dairy and meaty notes may be selected from the group of decanoic acid, butanoic acid, 3-hydroxy-2-butanone, 2,3-pentanedione, Tetrahydro-6-pentyl-2H-pyran-2-one, 6-heptyltetrahydro-2H-pyran-2-one, dodecanoic acid, ethyl lactate, octanoic acid, dairy extracts and processed dairy products and a combination thereof. Even more particularly, the ingredients capable of imparting a characteristic flavor note associated with dairy and meaty note may be selected from the group of decanoic acid, butanoic acid, 3-hydroxy-2-butanone, 2,3-pentanedione, tetrahydro-6-pentyl-2H-pyran-2-one and a combination thereof.

According to any embodiments of the present invention, the flavor composition comprises at least one, two, three, four, five, six, seven, eight, nine, ten or even more ingredients capable of imparting characteristic flavor note associated with dairy and meaty notes.

The concentration of ingredients capable of imparting a characteristic flavor note associated with dairy and meaty notes is in the range of from 0.001 to 10000 ppm ready-to-consume (RTC), preferably in a range from 0.001 to 1000 ppm, preferably in a range from 0.001 to 100 ppm, preferably in a range from 0.001 to 50 ppm, preferably in a range from 0.001 to 20 ppm, even more preferably in a range from 0.01 to 20 ppm. 2-hydroxy-4-methoxybenzaldehyde may be used in combination with such ingredients capable of imparting characteristic flavor note associated with dairy and meaty notes in any suitable ratio (w/w) ranging from 1:100000 to 500:1, or from 1:50000 to 200:1, or from, 1:10000 to 100:1, or from 1:1000 to 100:1, or from 1:500 to 50:1.

By “brown flavors note”, it is meant the normal meaning understood by a person skilled in the art, i.e. ingredients imparting, for example, cocoa, burnt sugar, caramel, coffee, nuts, seeds, maple, roasted, toasted, cooked or baked food flavors or any facet associated with said flavors.

A non-limiting list of suitable ingredients capable of imparting a characteristic flavor note associated with brown flavors note may be selected from the group of 3-methylbutanal, cocoa extract, 2-furanmethanol, 2-furancarboxaldehyde, 5-methyl-2-furancarboxaldehyde, 4-hydroxy-2,5-dimethyl-3-furanone, 2-ethyl-3-hydroxy-4H-pyran-4-one, 3-hydroxy-2-methyl-4H-pyran-4-one, brown sugar extract, cane sugar extract, tetramethylpyrazine, 2-methyl-propanal, 2-methyl-butanal, 2-acetyl-1-pyrroline, 2-acetyl-2-pyrroline, 2-acetyltetrahydropyridine, 2-acetyl-3,4,5,6-tetrahydropyridine, 2-acetyl-1,4,5,6-tetrahydropyridine, pyrrolidine, methylpyrazine, 2-ethyl-6-methylpyrazine, 2,3,5(6)-trimethylpyrazine, 2,5-dimethylpyrazine, 2,6-dimethylpyrazine 2-acetylpyridine, methyl tetrahydrofuranone, 1-(2-furanyl)-ethanone, 2-ethyl-5-methylpyrazine, 2-ethyl-6-methylpyrazine, 1-(2-pyrrolyl)-1-ethanone, 2-isopropyl-5-methylhexanal, 2-isopropyl-5-methyl-2-hexenal, 4-methyl-2-phenyl-2-pentenal, alpha-(3-methylbutylidene)-benzeneacetaldehyde, 1-(thiazol-2-yl)ethan-1-one, 2-furanmethanthiol, 1-(3-methylpyrazinyl)-ethanone, 2-ethyl-3-methyl-pyrazine, 2-((methyldithio)methyl)-furan, 1-(4,5-dihydro-1,3-thiazol-2-yl)-1-ethanone, 2,5-dihydro-4,5-dimethyl-2-(2-methylpropyl)-thiazole, dihydro-2,4,6-tris(2-methylpropyl)-4H-1,3,5-dithiazine, 2-decenal, benzaldehyde, massoia bark extracts, Tonka bean extract, fenugreek extracts, 5,6-dihydro-6-pentyl-2H-pyran-2-one, dihydro-5-pentyl-2(3H)-furanone, tetrahydro-6-pentyl-2H-pyran-2-one, 1,4-dimethoxy-benzene, 6-methyl-2H-1-benzopyran-2-one, 3,4-dihydro-2H-1-benzopyran-2-one, 1-benzopyran-2-one, 3-hydroxy-4,5-dimethyl-2(5H)-furanone, tetrahydro-6-propyl-2H-pyran-2-one, 6-butyltetrahydro-2H-pyran-2-one, 5-butyldihydro-2(3H)-furanone, 5-propyldihydro-2(3H)-furanone, 5-methyldihydro-2(3H)-furanone, 2,4-decadienal, 1-(pyrazin-2-yl)ethan-1-one, 5-methylhept-2-en-4-one, 2-hydroxy-3-methyl-2-cyclopenten-1-one, 3,4-dimethyl-1,2-cyclopentanedione, 3-ethyl-2,5-dimethylpyrazine, 2-ethyl-3,5-dimethylpyrazine, 6,7-dihydro-5-methyl-5H-cyclopentapyrazine, 2-ethylpyrazine, 2-methoxy-3-(1-methylethyl)-pyrazine, 2-ethyl-3-methoxy-pyrazine, 2-methoxy-3-methyl-pyrazine, 2-methoxy-5-methyl-pyrazine, 2-methylthio-3-methylpyrazine, 2-methylthio-5-methylpyrazine, 2-methylthio-6-methylpyrazine, and a combination thereof. Particularly, the ingredients capable of imparting a characteristic flavor note associated with brown flavors note may be selected from the group of 3-methylbutanal, cocoa extract, 2-furanmethanol, 2-furancarboxaldehyde, 5-methyl-2-furancarboxaldehyde, 4-hydroxy-2,5-dimethyl-3-furanone, 3-hydroxy-2-methyl-4H-pyran-4-one, tetramethylpyrazine, 2-methyl-propanal, 2-acetyl-1-pyrroline, 2,3,5(6)-trimethylpyrazine, 2,5-dimethylpyrazine, 2,6-dimethylpyrazine, 2-isopropyl-5-methyl-2-hexenal, 2-furanmethanthiol, 2-ethyl-3-methyl-pyrazine, 2-((methyldithio)methyl)-furan, benzaldehyde, massoia bark extracts fenugreek extracts, 5,6-dihydro-6-pentyl-2H-pyran-2-one, 1-benzopyran-2-one, 3-hydroxy-4,5-dimethyl-2(5H)-furanone, 2-acetylpyrazine, 2-hydroxy-3-methyl-2-cyclopenten-1-one, 2-ethyl-3,5-dimethylpyrazine and a combination thereof. Even more particularly, the ingredients capable of imparting a characteristic flavor note associated with brown flavors note may be selected from the group of 3-methylbutanal, cocoa extract, 2-furancarboxaldehyde, 4-hydroxy-2,5-dimethyl-3-furanone, 3-hydroxy-2-methyl-4H-pyran-4-one, 2,3,5(6)-trimethylpyrazine, 2-furanmethanthiol, benzaldehyde, 5,6-dihydro-6-pentyl-2H-pyran-2-one, 1-benzopyran-2-one, 2-hydroxy-3-methyl-2-cyclopenten-1-one and a combination thereof.

According to any embodiments of the present invention, the flavor composition comprises at least one, two, three, four, five, six, seven, eight, nine, ten or even more ingredients capable of imparting characteristic flavor note associated with brown flavors note.

The concentration of ingredients capable of imparting a characteristic flavor note associated with brown flavors note is in the range of from 0.0001 to 10000 ppm ready-to-consume (RTC), preferably in a range from 0.0005 to 1000 ppm, preferably in a range from 0.001 to 500 ppm, preferably in a range from 0.002 to 100 ppm, preferably in a range from 0.002 to 50 ppm, preferably in a range from 0.05 to 100 ppm, even more preferably in a range from 0.01 to 50 ppm.

2-hydroxy-4-methoxybenzaldehyde may be used in combination with such ingredients capable of imparting characteristic flavor note associated with brown flavors note in any suitable ratio (w/w) ranging from 1:100000 to 1000:1, or from 1:50000 to 500:1, or from, 1:10000 to 250:1, or from 1:1000 to 100:1, or from 1:500 to 100:1.

By “honey and botanicals note”, it is meant the normal meaning understood by a person skilled in the art, i.e. ingredients imparting, for example, honey, tea, spicy, herbs or plants flavors or any facet associated with said flavors.

A non-limiting list of suitable ingredients capable of imparting a characteristic flavor note associated with honey and botanicals note may selected from the group of 2-hydroxybenzaldehyde, beeswax extracts, phenylacetaldehyde, hexahydro-3,6-dimethyl-2(3H)-benzofuranone, 1-(2-hydroxy-4-methoxyphenyl) ethanone, 5-methyl-2(3H)-furanone, methyl 2-hydroxybenzoate, 1-octen-3-ol, 1-octen-3-one, 3-buten-2-one, 3-methyl-3-buten-2-one, hexanal, heptanal, 2,6-nonadienal, 1-phenyl-ethanone, 2,3-dimethylpyrazine, benzene ethanol, benzene acetic acid, methyl ester (9Z,12Z,15Z)-9,12,15-octadecatrienoic acid, mate extract, honey extracts, tea extracts, 2-(5-ethenyl-5-methyloxolan-2-yl)propan-2-ol, ginger extract, mint oil, benzoic acid phenylmethyl ester, 3-phenyl-2-propenal, 3-phenyl-2-propen-1-ol, 3-phenyl-2-propenoic acid, hay extract, flouve extract (Anthoxanthum odoratum or Anthoxanthum pilosum or Anthoxanthum villosum extract), ethyl ester benzenepropanoic acid, methyl benzoate and a combination thereof. Particularly, the ingredients capable of imparting a characteristic flavor note associated with honey and botanical note may selected from the group of phenylacetaldehyde, methyl 2-hydroxybenzoate, hexanal, (E,Z)-2,6-nonadienal, 1-phenyl-ethanone, 2,3-dimethylpyrazine, benzene ethanol, benzene acetic acid, mate extract, honey extracts, tea extracts, benzoic acid phenylmethyl ester, 3-phenyl-2-propenal, 3-phenyl-2-propenoic acid, hay extract, flouve extract (Anthoxanthum odoratum or Anthoxanthum pilosum or Anthoxanthum villosum extract) and a combination thereof. Even more particularly, the ingredients capable of imparting a characteristic flavor note associated with honey and botanical note are selected from the group of phenylacetaldehyde, hexanal, benzene ethanol, benzene acetic acid, mate extract, honey extracts, tea extracts and a combination thereof.

According to any embodiments of the present invention, the flavor composition comprises at least one, two, three, four, five, six, seven, eight, nine, ten or even more ingredients capable of imparting characteristic flavor note associated with honey and botanicals notes.

The concentration of ingredients capable of imparting a characteristic flavor note associated with honey and botanicals notes is in the range of from 0.001 to 20000 ppm ready-to-consume (RTC), preferably in a range from 0.005 to 2000 ppm, preferably in a range from 0.005 to 500 ppm, preferably in a range from 0.005 to 50 ppm, preferably in a range from 0.01 to 500 ppm, preferably in a range from 0.05 to 100 ppm, even more preferably in a range from 0.1 to 50 ppm.

2-hydroxy-4-methoxybenzaldehyde may be used in combination with such ingredients capable of imparting characteristic flavor note associated with honey and botanicals notes in any suitable ratio (w/w) ranging from 1:10000000 to 1000:1, or from 1:1000000 to 500:1, or from, 1:100000 to 250:1, or from 1:10000 to 100:1, or from 1:1000 to 50:1, or from 1:500 to 50:1.

By “fruits note”, it is meant the normal meaning understood by a person skilled in the art, i.e. ingredients imparting, for example, red fruits such as strawberry, raspberry, yellow fruits such as peach or apricot, exotic fruits such as mango or passion fruit or others flavors or any facet associated with said flavors.

A non-limiting list of suitable ingredients capable of imparting a characteristic flavor note associated with fruits note may be selected from the group of ethyl 3-phenyl-2-propenoate, methyl 3-phenyl-2-propenoate, ethyl ester benzoic acid, methyl ester benzoic acid, 5-hexyldihydro-2(3H)-furanone, 5-ethyldihydro-2(3H)-furanone, 6-hexyltetrahydro-2H-pyran-2-one, 5-heptyldihydro-2(3H)-furanone, 5-octyldihydro-2(3H)-furanone, 6-methyltetrahydro-2H-pyran-2-one, 2-methyl-butanoic acid, hexanoic acid, 1-pentanol, 1-octanol, 1-hexanol, (2E)-1-(2,6,6-trimethyl-1,3-cyclohexadien-1-yl)-2-buten-1-one, ethyl vinyl ketone, octanal, pentanal, 2-heptenal, 2-butenal, 2-hexenal, (3E)-4-(2,6,6-trimethyl-1-cyclohexen-1-yl)-3-buten-2-one, (E)-4-(2,5,6,6-tetramethyl-1-cyclohex-2-enyl)but-3-en-2-one, (E)-4-(2,6,6-trimethyl-1-cyclohex-2-enyl)but-3-en-2-one, ethyl lactate, ethyl acetate, ethyl butanoate, cis-3-hexenol, cis-3-hexenyl acetate, cis-3-hexenyl butyrate, ethyl hexanoate, ethyl isovalerate, 2-amino-methyl ester benzoic acid, 2-amino-ethyl ester benzoic acid, 2-(methylamino)-methyl ester benzoic acid, ethyl ester 2-methyl butanoic acid, ethyl ester octanoic acid, 1-butanol-3-methyl-acetate, 4-decenal, ethyl ester propanoic acid, 1,1-diethoxy-ethane, 2-(methylamino)-methyl ester benzoic acid, ethyl heptanoate and a combination thereof. Particularly, the ingredients capable of imparting a characteristic flavor note associated with fruits note may be selected from the group of ethyl 3-phenyl-2-propenoate, methyl 3-phenyl-2-propenoate, methyl ester benzoic acid, 5-hexyldihydro-2(3H)-furanone, 5-heptyldihydro-2(3H)-furanone, 5-octyldihydro-2(3H)-furanone, 2-methyl-butanoic acid, hexanoic acid, (2E)-1-(2,6,6-trimethyl-1,3-cyclohexadien-1-yl)-2-buten-1-one, (E)-2-hexenal, (3E)-4-(2,6,6-trimethyl-1-cyclohexen-1-yl)-3-buten-2-one, (E)-4-(2,5,6,6-tetramethyl-1-cyclohex-2-enyl)but-3-en-2-one, ethyl acetate, ethyl butanoate, cis-3-hexenol, cis-3-hexenyl acetate, ethyl hexanoate, ethyl isovalerate, 2-amino-methyl ester benzoic acid, 2-(methylamino)-methyl ester benzoic acid, 1-butanol-3-methyl-acetate, 2-methylethyl propanoate, methyl ester heptanoic acid and a combination thereof. Even more particularly, the ingredients capable of imparting a characteristic flavor note associated with fruits note may be selected from the group of methyl 3-phenyl-2-propenoate, 5-hexyldihydro-2(3H)-furanone, 5-heptyldihydro-2(3H)-furanone, 2-methyl-butanoic acid, hexanoic acid, (2E)-1-(2,6,6-trimethyl-1,3-cyclohexadien-1-yl)-2-buten-1-one, (3E)-4-(2,6,6-trimethyl-1-cyclohexen-1-yl)-3-buten-2-one, ethyl acetate, cis-3-hexenol, 2-amino-methyl ester benzoic acid and a combination thereof.

According to any embodiments of the present invention, the flavor composition comprises at least one, two, three, four, five, six, seven, eight, nine, ten or even more ingredients capable of imparting characteristic flavor note associated with fruits note.

The concentration of ingredients capable of imparting a characteristic flavor note associated with fruits note is in the range of from 0.0001 to 500 ppm ready-to-consume (RTC), preferably in a range from 0.0005 to 200 ppm, preferably in a range from 0.001 to 150 ppm, preferably in a range from 0.01 to 100 ppm, even more preferably in a range from 0.01 to 50 ppm.

2-hydroxy-4-methoxybenzaldehyde may be used in combination with such ingredients capable of imparting characteristic flavor note associated with fruits note in any suitable ratio (w/w) ranging from 1:5000 to 100:1, or from 1:2000 to 50:1, or from, 1:1000 to 25:1, or from 1:500 to 10:1, or from 1:200 to 10:1, or from 1:100 to 10:1.

By “alcoholic beverages”, it is meant the normal meaning understood by a person skilled in the art, i.e. ingredients imparting, for example, spirit, whisky, wine or other flavors or any facet associated with said flavors.

A non-limiting list of suitable ingredients capable of imparting a characteristic flavor note associated with alcoholic beverages note may be selected from the group of (−)-(1R,4E,9S)-4,11,11-trimethyl-8-methylenebicyclo[7.2.0]undec-4-ene, oakwood extract, 5-butyldihydro-4-methyl-2(3h)-furanone, chicory extract, cinnamon bark extract, clove extract, cardamon extract, marjoram extract, savory extract, gentian extract, chichonna extract, quasia amara extract, juniper extract, coriander extract, cognac extract, star anise oil, licorice extract, orange peel extract, lemon peel extract, oregano extract, thyme extract, nutmeg extract, cassia extract, rum extract, whisky extract, brandy extract, 5-allyl-1,2,3-trimethoxybenzene, ethyl ester propanoic acid, ethyl ester 2-propenoic acid, ethyl ester 2-butenoic acid, ethyl ester decanoic acid, 4-oxo-ethyl ester pentanoic acid, ethyl ester nonanoic acid, ethyl tetradecanoate, ethyl ester 2-butenoic acid, ethyl octanoate, ethyl ester dodecanoic acid and a combination thereof. Particularly, the ingredients capable of imparting a characteristic flavor note associated with alcoholic beverages note may be selected from the group of (−)-(1R,4E,9S)-4,11,11-trimethyl-8-methylenebicyclo[7.2.0]undec-4-ene, oakwood extract, cinnamon bark extract, clove extract, gentian extract, juniper extract, cognac extract, licorice extract, orange peel extract, lemon peel extract, rum extract, whisky extract, brandy extract, ethyl ester propanoic acid, ethyl ester 2-propenoic acid, ethyl ester decanoic acid and a combination thereof. Even more particularly, the ingredients capable of imparting a characteristic flavor note associated with alcoholic beverages note are selected from the group of (−)-(1R,4E,9S)-4,11,11-trimethyl-8-methylenebicyclo[7.2.0]undec-4-ene, oakwood extract, cinnamon bark extract, clove extract, juniper extract, rum extract and a combination thereof.

According to any embodiments of the present invention, the flavor composition comprises at least one, two, three, four, five, six, seven, eight, nine, ten or even more ingredients capable of imparting characteristic flavor note associated with alcoholic beverages note.

The concentration of ingredients capable of imparting a characteristic flavor note associated with alcoholic beverages note is in the range of from 0.001 to 50000 ppm ready-to-consume (RTC), preferably in a range from 0.005 to 20000 ppm, preferably in a range from 0.01 to 10000 ppm, preferably in a range from 0.05 to 1000 ppm, even more preferably in a range from 0.05 to 500 ppm.

2-hydroxy-4-methoxybenzaldehyde may be used in combination with such ingredients capable of imparting characteristic flavor note associated with alcoholic beverages note in any suitable ratio (w/w) ranging from 1:5000000 to 50:1, or from 1:2000000 to 20:1, or from, 1:1000000 to 10:1, or from 1:100000 to 10:1, or from 1:50000 to 10:1.

According to any embodiments of the present invention, the flavor composition comprises at least one, two, three, four, five, six, seven, eight, nine, ten or even more ingredients capable of imparting characteristic flavor note associated with brown flavors note and at least one, two, three, four, five, six, seven, eight, nine, ten or even more ingredients capable of imparting characteristic flavor note associated with dairy and meaty notes, honey and botanicals notes, fruits note and/or alcoholic beverages note.

According to any embodiments of the present invention, the flavor composition comprises at least one, two, three, four, five, six, seven, eight, nine, ten or even more ingredients capable of imparting characteristic flavor note associated with brown flavors note and at least one, two, three, four, five, six, seven, eight, nine, ten or even more ingredients capable of imparting characteristic flavor note associated with dairy and meaty notes and/or at least one, two, three, four, five, six, seven, eight, nine, ten or even more ingredients capable of imparting characteristic flavor note associated with phenolic note.

According to any embodiments of the present invention, the flavor composition is devoid of ingredients capable of imparting characteristic flavor note associated with phenolic note.

According to any embodiments of the present invention, the flavor composition comprises at least one, two, three, four, five, six, seven, eight, nine, ten or even more ingredients capable of imparting characteristic flavor note associated with phenolic note and at least one, two, three, four, five, six, seven, eight, nine, ten or even more ingredients capable of imparting characteristic flavor note associated with dairy and meaty notes.

According to any embodiments of the present invention, the flavor composition comprises at least one, two, three, four, five, six, seven, eight, nine, ten or even more ingredients capable of imparting characteristic flavor note associated with phenolic note and at least one, two, three, four, five, six, seven, eight, nine, ten or even more ingredients capable of imparting characteristic flavor note associated with brown flavors note.

According to any embodiments of the present invention, the flavor composition comprises at least one, two, three, four, five, six, seven, eight, nine, ten or even more ingredients capable of imparting characteristic flavor note associated with phenolic note and at least one, two, three, four, five, six, seven, eight, nine, ten or even more ingredients capable of imparting characteristic flavor note associated with honey and botanicals note.

According to any embodiments of the present invention, the flavor composition comprises at least one, two, three, four, five, six, seven, eight, nine, ten or even more ingredients capable of imparting characteristic flavor note associated with phenolic note and at least one, two, three, four, five, six, seven, eight, nine, ten or even more ingredients capable of imparting characteristic flavor note associated with fruits note.

According to any embodiments of the present invention, the flavor composition comprises at least one, two, three, four, five, six, seven, eight, nine, ten or even more ingredients capable of imparting characteristic flavor note associated with phenolic note and at least one, two, three, four, five, six, seven, eight, nine, ten or even more ingredients capable of imparting characteristic flavor note associated with alcoholic beverages note.

According to any embodiments of the present invention, the flavor composition comprises at least one, two, three, four, five, six, seven, eight, nine, ten or even more ingredients capable of imparting characteristic flavor note associated with dairy and meaty notes and at least one, two, three, four, five, six, seven, eight, nine, ten or even more ingredients capable of imparting characteristic flavor note associated with fruits note.

According to any embodiments of the present invention, the flavor composition comprises at least one, two, three, four, five, six, seven, eight, nine, ten or even more ingredients capable of imparting characteristic flavor note associated with dairy and meaty notes and at least one, two, three, four, five, six, seven, eight, nine, ten or even more ingredients capable of imparting characteristic flavor note associated with brown note.

According to any embodiments of the present invention, the flavor composition comprises at least one, two, three, four, five, six, seven, eight, nine, ten or even more ingredients capable of imparting characteristic flavor note associated with dairy and meaty notes, at least one, two, three, four, five, six, seven, eight, nine, ten or even more ingredients capable of imparting characteristic flavor note associated with brown note, at least one, two, three, four, five, six, seven, eight, nine, ten or even more ingredients capable of imparting characteristic flavor note associated with phenolic note and optionally, at least one, two, three, four, five, six, seven, eight, nine, ten or even more ingredients capable of imparting characteristic flavor note associated with fruits note.

According to any embodiments of the present invention, the flavor composition comprises at least one, two, three, four, five, six, seven, eight, nine, ten or even more ingredients capable of imparting characteristic flavor note associated with brown notes and at least one, two, three, four, five, six, seven, eight, nine, ten or even more ingredients capable of imparting characteristic flavor note associated with honey and botanicals notes.

According to any embodiments of the present invention, the flavor composition comprises at least one, two, three, four, five, six, seven, eight, nine, ten or even more ingredients capable of imparting characteristic flavor note associated with fruits note and at least one, two, three, four, five, six, seven, eight, nine, ten or even more ingredients capable of imparting characteristic flavor note associated with alcoholic beverages note.

The invention's flavor compositions can include any suitable sweeteners or combination of sweeteners. In some embodiments, the sweetener is a common saccharide sweetener, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, rebaudioside C, rebaudioside D, rebaudioside M, rebaudioside type beta, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the sweetener is a combination of two or more of the sweeteners set forth in this paragraph. In some embodiments, the sweetener may combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar may be sucrose. In some embodiments, the sugar may be a combination of fructose and glucose.

The sweetener can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the ingestible compositions are free (or, in some embodiments) substantially free of stevia-derived sweeteners, such as steviol glycosides, glucosylated steviol glycosides, or rebaudiosides. For example, in some embodiments, the ingestible compositions are either free of stevia-derived sweeteners or comprise stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

In certain particular embodiments, the invention's flavor composition comprises sucrose and 2-hydroxy-4-methoxybenzaldehyde. In some such embodiments, the introduction of the 2-hydroxy-4-methoxybenzaldehyde permits one to use less sucrose (such as more than 10% less, more than 20% less, more than 30% less, more than 40% less, more than 50% less, more than 60% less, or more than 70% less) and still achieve a level of sweetness characteristic of a comparable product that employs more sucrose. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like. The sucrose can be introduced in any suitable form, such as natural syrups (cane syrup) and the like.

In certain particular embodiments, the ingestible composition comprises fructose and the 2-hydroxy-4-methoxybenzaldehyde. In some such embodiments, the introduction of the 2-hydroxy-4-methoxybenzaldehyde permits one to use less fructose (such as more than 10% less, more than 20% less, more than 30% less, more than 40% less, more than 50% less, more than 60% less, or more than 70% less) and still achieve a level of sweetness characteristic of a comparable product that employs more fructose. In some embodiments, the concentration 2-hydroxy-4-methoxybenzaldehyde, is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm.

In some embodiments, the ingestible composition is a food product, such as any of those specifically listed below. In other embodiments, the ingestible composition is a beverage product, such as a soda, and the like. The fructose can be supplied in any suitable form, such as natural syrups, high-fructose corn syrup, and the like.

In certain particular embodiments, the ingestible composition comprises high-fructose corn syrup and 2-hydroxy-4-methoxybenzaldehyde. In some such embodiments, the introduction of the 2-hydroxy-4-methoxybenzaldehyde permits one to use less high-fructose corn syrup (such as more than 10% less, more than 20% less, more than 30% less, more than 40% less, more than 50% less, more than 60% less, or more than 70% less) and still achieve a level of sweetness characteristic of a comparable product that employs more high-fructose corn syrup. In some embodiments, the concentration of 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm In some embodiments, the ingestible composition is a food product, such as any of those specifically listed below. In other embodiments, the ingestible composition is a beverage product, such as a soda, and the like.

In certain particular embodiments, the ingestible composition comprises glucose (for example, D-glucose, in either its alpha or beta forms, or a combination thereof) and 2-hydroxy-4-methoxybenzaldehyde. In some such embodiments, the introduction of the 2-hydroxy-4-methoxybenzaldehyde permits one to use less glucose (such as more than 10% less, more than 20% less, more than 30% less, more than 40% less, more than 50% less, more than 60% less, or more than 70% less) and still achieve a level of sweetness characteristic of a comparable product that employs more glucose. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like. The glucose can be introduced in any suitable form, such as natural syrups and the like.

In certain particular embodiments, the ingestible composition comprises sucralose and 2-hydroxy-4-methoxybenzaldehyde. In some such embodiments, the introduction of the 2-hydroxy-4-methoxybenzaldehyde permits one to use less sucralose (such as more than 10% less, more than 20% less, more than 30% less, more than 40% less, more than 50% less, more than 60% less, or more than 70% less) and still achieve a level of sweetness characteristic of a comparable product that employs more sucralose. In some embodiments, the concentration of 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises rebaudiosides (such as rebaudioside A, rebaudioside D, rebaudioside E, rebaudioside M, or any combination thereof) and 2-hydroxy-4-methoxybenzaldehyde. In some such embodiments, the introduction of the 2-hydroxy-4-methoxybenzaldehyde permits one to use less rebaudioside (such as more than 10% less, more than 20% less, more than 30% less, more than 40% less, more than 50% less, more than 60% less, or more than 70% less) and still achieve a level of sweetness characteristic of a comparable product that employs more rebaudioside. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises acefulfame K and 2-hydroxy-4-methoxybenzaldehyde. In some such embodiments, the introduction of the 2-hydroxy-4-methoxybenzaldehyde permits one to use less acesulfame K (such as more than 10% less, more than 20% less, more than 30% less, more than 40% less, more than 50% less, more than 60% less, or more than 70% less) and still achieve a level of sweetness characteristic of a comparable product that employs more acesulfame K. In some embodiments, the concentration of 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises allulose and 2-hydroxy-4-methoxybenzaldehyde. In some such embodiments, the introduction of the 2-hydroxy-4-methoxybenzaldehyde permits one to use less allulose (such as more than 10% less, more than 20% less, more than 30% less, more than 40% less, more than 50% less, more than 60% less, or more than 70% less) and still achieve a level of sweetness characteristic of a comparable product that employs more allulose. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises erythritol and 2-hydroxy-4-methoxybenzaldehyde. In some such embodiments, the introduction of the 2-hydroxy-4-methoxybenzaldehyde permits one to use less erythritol (such as more than 10% less, more than 20% less, more than 30% less, more than 40% less, more than 50% less, more than 60% less, or more than 70% less) and still achieve a level of sweetness characteristic of a comparable product that employs more erythritol. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises aspartame and 2-hydroxy-4-methoxybenzaldehyde. In some such embodiments, the introduction of the 2-hydroxy-4-methoxybenzaldehyde permits one to use less aspartame (such as more than 10% less, more than 20% less, more than 30% less, more than 40% less, more than 50% less, more than 60% less, or more than 70% less) and still achieve a level of sweetness characteristic of a comparable product that employs more aspartame. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises cyclamate and 2-hydroxy-4-methoxybenzaldehyde. In some such embodiments, the introduction of the 2-hydroxy-4-methoxybenzaldehyde permits one to use less cyclamate (such as more than 10% less, more than 20% less, more than 30% less, more than 40% less, more than 50% less, more than 60% less, or more than 70% less) and still achieve a level of sweetness characteristic of a comparable product that employs more cyclamate. In some embodiments, the concentration of the 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like.

In certain particular embodiments, the ingestible composition comprises a mogroside (such as mogroside III, mogroside IV, mogroside V, siamenoside I, isomogroside V, mogroside IV_{E}, mogroside III_{E}, 11-oxomogroside V, the α-1,6-isomer of siamenoside I, and any combinations thereof) and 2-hydroxy-4-methoxybenzaldehyde. In some such embodiments, the introduction of 2-hydroxy-4-methoxybenzaldehyde permits one to use less a mogroside (such as more than 10% less, more than 20% less, more than 30% less, more than 40% less, more than 50% less, more than 60% less, or more than 70% less) and still achieve a level of sweetness characteristic of a comparable product that employs more mogroside. In some embodiments, the concentration of 2-hydroxy-4-methoxybenzaldehyde is no more than 20 ppm, or no more than 10 ppm, or no more than 5 ppm, or no more than 2 ppm, or no more than 1 ppm, or no more than 0.5 ppm, or no more than 0.1 ppm, or no more than 0.05 ppm. Such ingestible compositions can be in any suitable form. In some embodiments, the ingestible composition is a food product, such as any of those specifically listed below. In other embodiments, the ingestible composition is a beverage product, such as a soda, and the like. Additional mogroside compounds that may be suitably used are described in U.S. Patent Application Publication No. 2017/0119032.

The invention's flavor compositions can include one or more additional flavor-modifying compounds also called modulators or trigeminal sensates, such as compounds that enhance sweetness (e.g., hesperetin, naringenin, glucosylated steviol glycosides, etc.), compounds that block bitterness (Naringenin, 3-(1-((3,5-dimethylisoxazol-4-yl)methyl)-1H-pyrazol-4-yl)-1-(3-hydroxybenzyl)imidazolidine-2,4-dione), compounds that enhance umami, compounds that reduce sourness or licorice taste, compounds that enhance saltiness, compounds that enhance a cooling effect, or any combinations of the foregoing.

Thus, in some embodiments, ingestible compositions disclosed herein comprise the 2-hydroxy-4-methoxybenzaldehyde, according to any of the embodiments or combination of embodiments set forth above, are combined with one or more other sweetness enhancing compounds. Such sweetness enhancing compounds include, but are not limited to, naturally derived compounds, such as hesperitin, naringenin, glucosylated steviol glycosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. 2-hydroxy-4-methoxybenzaldehyde may be used in combination with such other sweetness enhancers in any suitable ratio (w/w) ranging from 1:15000 to 1:1, or from 1:10000 to 1:1, or from, 1:5000 to 1:1, or from 1:500 to 1:1, or from 1:100 to 1:1, or from 1:50 to 1:1 or from 1:20 to 1:1. In some embodiments of any of the preceding embodiments, 2-hydroxy-4-methoxybenzaldehyde is combined with glucosylated steviol glycosides in any of the above ratios. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth.

In some further embodiments, ingestible compositions disclosed herein comprise 2-hydroxy-4-methoxybenzaldehyde, according to any of the embodiments or combination of embodiments set forth above, are combined with one or more umami enhancing compounds. Such umami enhancing compounds include, but are not limited to, naturally derived compounds, such as ericamide, or synthetic compounds, such as any compounds set forth in U.S. Pat. Nos. 8,735,081; 8,124,121; and 8,968,708. 2-hydroxy-4-methoxybenzaldehyde may be used in combination with such umami enhancers in any suitable ratio (w/w) ranging from 1:100000 to 1:1, or from 1:50000 to 1:1, or from, 1:10000 to 1:1, or from 1:500 to 1:1, or from 1:100 to 1:1, or from 1:50 to 1:1 such as 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1. In some further embodiments, ingestible compositions disclosed herein comprise 2-hydroxy-4-methoxybenzaldehyde, according to any of the embodiments or combination of embodiments set forth above, are combined with one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. Non limited-examples of suitable cooling agent includes WS-23 (2-Isopropyl-N,2,3-trimethylbutyramide), FEMA 3804; WS-3 (N-Ethyl-p-menthane-3-carboxamide), FEMA 3455; WS-5 [Ethyl 3-(p-menthane-3-carboxamido)acetate], FEMA 4309; WS-12 (1R,2S,5R)—N-(4-Methoxyphenyl)-p-menthanecarboxamide, FEMA 4681; WS-27 (N-Ethyl-2,2-diisopropylbutanamide), FEMA 4557; N-Cyclopropyl-5-methyl-2-isopropylcyclohexanecarboxamide, FEMA 4693, WS-116 (N-(1,1-Dimethyl-2-hydroxyethyl)-2,2-diethylbutanamide), N-(1,1-Dimethyl-2-hydroxyethyl)2,2-diethylbutanamide, FEMA 4603, Menthoxyethanol, FEMA 4154, N-(4-cyanomethylphenyl)-p-menthanecarboxamide, FEMA 4496; N-(2-(Pyridin-2-yl)ethyl)-3-p-menthanecaboxamide, FEMA 4549; N-(2-Hydroxyethyl)-2-isopropyl-2,3-dimethylbutanamide, FEMA 4602 and (also N-(4-(carbamoylmethyl)phenyl)-menthylcarboxamide, FEMA 4684; (1R,2S,5R)—N-(4-Methoxyphenyl)-p-menthanecarboxamide (WS-12), FEMA 4681; (2S,5R)—N-[4-(2-Amino-2-oxoethyl)phenyl]-p-menthanecarboxamide, FEMA 4684; and N-Cyclopropyl-5-methyl-2-isopropylcyclohexanecarbonecarboxamide, FEMA 4693; 2-[(2-p-Menthoxy)ethoxy]ethanol, FEMA 4718; (2,6-Diethyl-5-isopropyl-2-methyltetrahydropyran, FEMA 4680); trans-4-tert-Butylcyclohexanol, FEMA 4724; 2-(p-tolyloxy)-N-(1H-pyrazol-5-yl)-N-((thiophen-2-yl)methyl)acetamide, FEMA 4809; Menthone glycerol ketal, FEMA 3807; menthone glyceryl ketal (FEMA GRAS 3808); (−)-Menthoxypropane-1,2-diol; 3-(1-Menthoxy)-2-methylpropane-1,2-diol, FEMA 3849; Isopulegol; (+)-cis & (−)-trans p-Menthane-3,8-diol, Ratio˜62:38, FEMA 4053; 2,3-dihydroxy-p-menthane; 3,3,5-trimethylcyclohexanone glycerol ketal; menthyl pyrrolidone carboxylate; (1R,3R,4S)-3-menthyl-3,6-dioxaheptanoate; (1R,2S,5R)-3-menthyl methoxyacetate; (1R,2S,5R)-3-menthyl 3,6,9-trioxadecanoate; (1R,2S,5R)-3-menthyl 3.6,9-trioxadecanoate; (1R,2S,5R)-3-menthyl (2-hydroxyethoxy)acetate; (1R,2S,5R)-menthyl 11-hydroxy-3,6,9-trioxaundecanoate; Cubebol, FEMA 4497; N-(4-cyanomethylphenyl) p-menthanecarboxamide, FEMA 4496; 2-isopropyl-5-methylcyclohexyl 4-(dimethylamino)-4-oxobutanoate, FEMA 4230; N-(4-cyanomethylphenyl) p-menthanecarboxamide, FEMA 4496; N-(2-pyridin-2-ylethyl) p-menthanecarboxamide, FEMA 4549, Menthyl lactate, FEMA 3748; 6-isopropyl-3,9-dimethyl-1,4-dioxaspiro[4.5]decan-2-one, FEMA 4285; N-benzo[1,3] dioxol-5-yl-3-p-menthanecarboxamide; N-(1-isopropyl-1,2-dimethylpropyl)-1,3-benzodioxole-5-carboxamide; N—(R)-2-oxotetrahydrofuran-3-yl-(1R,2S,5R)-p-menthane-3-carboxamide; mixture of 2,2,5,6,6-pentamethyl-2,3,6,6a-tetrahydropentalen-3a(1H)-ol and 5-(2-hydroxy-2-methylpropyl)-3,4,4-trimethylcyclopent-2-en-1-one; (1R,2S,5R)-2-isopropyl-5-methyl-N-(2-(pyridin-2-yl)ethyl)cyclohexanecarboxamide, FEMA 4549; (2S,5R)-2-isopropyl-5-methyl-N-(2-(pyridin-4-yl)ethyl)cyclohexanecarboxamide; N-(4-cyanomethylphenyl) p-menthanecarboxamide, FEMA 4496; (1S,2S,5R)—N-(4-(cyanomethyl)phenyl)-2-isopropyl-5-methylcyclohexanecarboxamide; 1/7-isopropyl-4/5-methyl-bicyclo[2.2.2]oct-5-ene derivatives; 4-methoxy-N-phenyl-N-[2-(pyridin-2-yl)ethyl]benzamide; 4-methoxy-N-phenyl-N-[2-(pyridin-2-yl)ethyl]benzenesulfonamide; 4-chloro-N-phenyl-N-[2-(pyridin-2-yl)ethyl]benzenesulfonamide; 4-cyano-N-phenyl-N-[2-(pyridin-2-yl)ethyl]benzenesulfonamid; 4-((benzhydrylamino)methyl)-2-methoxyphenol; 4-((bis(4-methoxyphenyl)-methylamino)-methyl)-2-methoxyphenol; 4-((1,2-diphenylethylamino)methyl)-2-methoxyphenol; 4-((benzhydryloxy)methyl)-2-methoxyphenol, 4-((9H-fluoren-9-ylamino)methyl)-2-methoxyphenol; 4-((benzhydrylamino)methyl)-2-ethoxyphenol; 1-(4-methoxyphenyl)-2-(1-methyl-1H-benzo[d]imidazol-2-yl)vinyl4-methoxybenzoate; 2-(1-isopropyl-6-methyl-1H-benzo[d]imidazol-2-yl)-1-(4-methoxyphenyl)vinyl4-methoxybenzoate; (Z)-2-(1-isopropyl-5-methyl-1H-benzo[d]imidazol-2-yl)-1-(4-methoxy-phenyl)vinyl-4-methoxybenzoate; 3-alkyl-p-methan-3-ol derivatives; derivatives of fenchyl, D-bornyl, L-bornyl, exo-norbornyl, 2-methylisobornyl, 2-ethylfenchyl, 2-methylbornyl, cis-pinan-2-yl, verbanyl and isobornyl; menthyl oxamate derivatives; menthyl 3-oxocarboxylic acid esters; N alpha-(Menthanecarbonyl)amino acid amides; p-menthane carboxamide and WS-23 analogs; (−)-(1R,2R,4S)-dihydroumbellulol; p-menthane alkyloxy amides; cyclohexane derivatives; butone derivatives; a mixture of 3-menthoxy-1-propanol and 1-menthoxy-2-propanol; 1-[2-hydroxyphenyl]-4-[2-nitrophenyl-]-1,2,3,6-tetrahydropyrimidine-2-one; 4-methyl-3-(1-pyrrolidinyl)-2[5H]-furanone; and combinations thereof. Preferably, the cooling agent may be selected from the group consisting of menthol, menthol methyl ether, menthone glyceryl acetal (FEMA GRAS 3807), menthone glyceryl ketal (FEMA GRAS 3808), menthyl lactate (FEMA GRAS 3748), menthyl acetate, menthol ethylene glycol carbonate (FEMA GRAS 3805), menthol propylene glycol carbonate (FEMA GRAS 3806), menthyl-N-ethyloxamate, monomethyl succinate (FEMA GRAS 3810), monomenthyl glutamate (FEMA GRAS 4006), menthoxy-1,2-propanediol (FEMA GRAS 3784), menthoxy-2-methyl-1,2-propanediol (FEMA GRAS 3849), (1R,2S,5R)—N-(4-(cyanomethyl)phenyl)menthylcarboxamide (FEMA GRAS 4496), (1R,2S,5R)—N-(2-(pyridin-2-yl)ethyl)menthylcarboxamide (FEMA GRAS 4549), the menthane carboxylic acid esters and amides WS-3, WS-4, WS-5, WS-12, WS-14, WS-30 and mixtures thereof. 2-hydroxy-4-methoxybenzaldehyde may be used in combination with such cooling enhancers in any suitable ratio (w/w) ranging from 1:10000 to 1:10, or from 1:5000 to 1:10, or from, 1:1000 to :1:20, or from 1:500 to 1:20, or from 1:200 to 1:50.

In some further embodiments, ingestible compositions disclosed herein comprise 2-hydroxy-4-methoxybenzaldehyde, according to any of the embodiments or combination of embodiments set forth above, are combined with one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759. 2-hydroxy-4-methoxybenzaldehyde may be used in combination with such bitterness blockers in any suitable ratio (w/w) ranging from 1:100000 to 1:1, or from 1:10000 to 1:10, or from, 1:1000 to :1:10, or from 1:500 to 1:20, or from 1:200 to 1:20.

In some further embodiments, ingestible compositions disclosed herein comprise 2-hydroxy-4-methoxybenzaldehyde, according to any of the embodiments or combination of embodiments set forth above, are combined with one or more sour taste modulating compounds. 2-hydroxy-4-methoxybenzaldehyde may be used in combination with such sour taste modulating compounds in any suitable ratio (w/w) ranging from 1:100000 to 1:1, or from 1:10000 to 1:10, or from, 1:1000 to :1:10, or from 1:500 to 1:20, or from 1:200 to 1:20.

In some further embodiments, ingestible compositions disclosed herein comprise 2-hydroxy-4-methoxybenzaldehyde, according to any of the embodiments or combination of embodiments set forth above, are combined with one or more mouthfeel modifying compounds. Such mouthfeel modifying compounds include, but are not limited to, tannins, cellulosic materials, bamboo powder, and the like. 2-hydroxy-4-methoxybenzaldehyde may be used in combination with such mouthfeel enhancers in any suitable ratio (w/w) ranging from 1:1000000 to 1:1, or from 1:100000 to 1:10, or from, 1:10000 to :1:100, or from 1:1000, or from 1:200 to 1:100.

In some further embodiments, ingestible compositions disclosed herein comprise 2-hydroxy-4-methoxybenzaldehyde, according to any of the embodiments or combination of embodiments set forth above, are combined with one or more flavor masking compounds. Such flavor masking compounds include, but are not limited to, cellulosic materials, materials extracted from fungus, materials extracted from plants, citric acid, carbonic acid (or carbonates), and the like. 2-hydroxy-4-methoxybenzaldehyde may be used in combination with such mouthfeel enhancers in any suitable ratio (w/w) ranging from 1:1000000 to 1:1, or from 1:100000 to 1:10, or from, 1:10000 to :1:100, or from 1:1000 to :1:100, or from 1:200 to :1:100.

According to any one of the above embodiments, the invention's composition may further comprise one or more flavoring co-ingredient.

By “flavoring co-ingredient” it is meant here a compound, which is used in flavoring preparations or compositions to impart a hedonic effect. In other words, such an ingredient, to be considered as being a flavoring one, must be recognized by a person skilled in the art as being able to impart or modify in a positive or pleasant way the taste of a composition, and not just as having a taste. Said flavoring co-ingredient is an ingredient not yet already cited.

The nature and type of the flavoring co-ingredients present in the composition do not warrant a more detailed description here, the skilled person being able to select them on the basis of its general knowledge and according to intended use or application and the desired organoleptic effect. In general terms, these flavoring co-ingredients belong to chemical classes as varied as alcohols, aldehydes, ketones, esters, ethers, acetates, nitriles, terpenoids, nitrogenous or sulphurous heterocyclic compounds and essential oils, and said flavoring co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor. It is also understood that said co-ingredients may also be compounds known to release in a controlled manner various types of flavoring compounds.

A non-limiting list of suitable flavoring co-ingredient which could be used includes (4-methoxyphenyl)methyl formate, 4-methoxy-benzenemethanol acetate, ethyl benzoate, 1-(2-hydroxy-4-methoxyphenyl)ethenone, benzenethanol, ethyl propanoate, ethyl 2-methylpropanoate, methyl heptanoate, ethyl 4-oxopentanoate, ethyl nonanoate, methyl 2-aminobenzoate, ethyl 2-aminobenzoate, methyl 2-(methylamino)benzoate, ethyl 3-phenylpropanoate, methyl 4-methoxybenzoate, 3-hydroxy-4-methoxybenzaldehyde, ethyl 4-hydroxybenzoate, (E)-3-(4-hydroxy-3-methoxy-1-phenyl)-2-propenal, ethyl prop-2-enoate, ethyl but-2-enoate, ethyl 2-methylbutanoate, 2-methyl butanoic acid, ethyl dodecanoate, ethyl 4-methoxybenzoate, (E)-2-butenal, 5-ethyl-4-hydroxy-2-methyl-3(2H)-furanone, 2-nonanone, S-methyl ester butanethioic acid 4-hydroxyl-3-methoxybenzaldehyde and a combination thereof.

According to any one of the above embodiments, the invention's composition may comprise at least one flavor. The term “flavor carrier” designates a material which is substantially neutral from a flavor point of view, insofar as it does not significantly alter the organoleptic properties of flavoring ingredients. The carrier may be a liquid or a solid.

Suitable liquid carriers include, for instance, an emulsifying system, i.e. a solvent and a surfactant system, or a solvent commonly used in flavors. A detailed description of the nature and type of solvents commonly used in flavor cannot be exhaustive. Suitable solvents used in flavor include, for instance, propylene glycol, triacetine, caprylic/capric triglyceride (Neobee©), triethyl citrate, benzylic alcohol, ethanol, isopropanol, citrus terpenes, vegetable oils such as Linseed oil, sunflower oil or coconut oil, glycerol.

Suitable solid carriers include, for instance, absorbing gums or polymers, or even encapsulating materials. Examples of such materials may comprise wall-forming and plasticizing materials, such as mono, di- or polysaccharides, natural or modified starches, hydrocolloids, cellulose derivatives, polyvinyl acetates, polyvinylalcohols, xanthan gum, arabic gum, acacia gum or yet the materials cited in reference texts such as H. Scherz, Hydrokolloid: Stabilisatoren, Dickungs-und Geliermittel in Lebensmitteln, Band 2 der Schriftenreihe Lebensmittelchemie, Lebensmittelqualität, Behr's VerlagGmbH & Co., Hamburg, 1996. Encapsulation is a well-known process to a person skilled in the art, and may be performed, for instance, using techniques such as spray-drying, agglomeration, extrusion, coating, plating, coacervation and the like.

The invention's composition may comprise at least one flavor adjuvant. By “flavor adjuvant”, it is meant here an ingredient capable of imparting additional added benefit such as a color (e.g. caramel), chemical stability, and so on. A detailed description of the nature and type of adjuvant commonly used in flavoring compositions cannot be exhaustive. Nevertheless, such adjuvants are well known to a person skilled in the art who will be able to select them on the basis of its general knowledge and according to intended use or application. One may cite as specific non-limiting examples the following: viscosity agents (e.g. emulsifier, thickeners, gelling and/or rheology modifiers, e.g. pectin or agar gum), stabilizing agents (e.g. antioxidant, heat/light and or buffers agents e.g. citric acid), coloring agents (e.g. natural or synthetic or natural extract imparting color), preservatives (e.g. antibacterial or antimicrobial or antifungal agents, e.g. benzoic acid), vitamins and mixtures thereof.

According to any one of the above embodiments, the flavored composition may further comprise ingredient imparting a warming, a tingling, a salivating, a cleaning or an alcohol enhancement effect such as capsicum extract, spice extract (e.g. ginger, maniguette, all types of peppers including Sichuan, piperine, capsaicine, jambu extract, spilanthol.

It is understood that a person skilled in the art is perfectly able to design optimal formulations for the desired effect by admixing the above-mentioned components of a flavoring composition, simply by applying the standard knowledge of the art as well as by trial and error methodologies.

For the sake of clarity, it is also understood that any mixture resulting directly from a chemical synthesis, e.g. a reaction medium without an adequate purification, in which the compounds of the invention would be involved as a starting, intermediate or end-product could not be considered as a flavoring composition according to the invention as far as said mixture does not provide the inventive compound in a suitable form for flavor. Thus, unpurified reaction mixtures are generally excluded from the present invention unless otherwise specified.

Another object of the present invention is the use of the invention's composition as flavoring composition. In other words, it concerns a method or a process to confer, enhance, improve or modify the odor/taste properties of a flavoring composition or of a flavored article, which method comprises adding to said composition or article an effective amount of the invention's composition, e.g. to impart its typical note.

By “use of the invention's composition” it has to be understood here also the use of any composition containing the invention's composition and which can be advantageously employed in the flavor industry.

Furthermore, the invention's composition can be advantageously used in all the fields of flavor to positively impart or modify the taste of a consumer product into which said composition is added. Consequently, the present invention relates to a flavored consumer product comprising the invention's composition as defined above.

For the sake of clarity, by “flavored consumer product” it is meant to designate an edible product or oral composition such as, for example, pharmaceutical compositions, edible gel mixes and compositions, dental compositions, foodstuffs beverages and beverage products. The flavored consumer product may be in a different form. A non-exhaustive list of suitable form of the consumer product may include fried, frozen, marinated, battered, chilled, dehydrated, powder blended, canned, reconstituted, retorted, baked, cooked, fermented, microfiltered, pasteurized, blended or preserved. Therefore, a flavored consumer product according to the invention comprises the invention's composition, as well as optional benefit agents, corresponding to taste and flavor profile of the desired edible product, e.g. a cream dessert.

The nature and type of the constituents of the foodstuffs or beverages do not warrant a more detailed description here, the skilled person being able to select them on the basis of his general knowledge and according to the nature of said product.

Typical examples of said flavored consumer product include:
Baked goods comprising any cereal and/or leguminous and/or pulses and/or nut and/or plant derived ingredients (e.g. breads, dry biscuits, cakes, rice cakes, rice crackers, cookies, crackers, donuts, muffins, pastries, pre-mixes, other baked goods),
Non-alcoholic beverages (e.g. aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, sports/energy powder mixes, juice drinks, vegetable juices, vegetable juice preparations, broth drinks),
Alcoholic beverages (e.g. beer and malt beverages, fruit spirits, cream liquors, spirituous beverages, wines, liquors),
Instant or ready-to-drink beverages (e.g. vegetable drinks, powdered soft drinks, instant coffees and teas, black teas, green teas, oolong teas, herbal infusions, cacaos (e.g. water-based), tea-based drinks, coffee-based drinks, cacao-based drinks, infusions, syrups, frozen fruits, frozen fruit juices, water-based ices, fruit ices, sorbets),
Nuts such as peanut spread, other nuts or seeds paste or spread (e.g. sesame paste, hazelnut paste . . . ),
Other grains such as meal or beverages preparation made from soya, maize, lupin, pea, faba, lentils, rice, millet, sorghum, wheat, oat, canola, chickpea, barley, any other pulses,
Cereal products (e.g. breakfast cereals, muesli, cereal bars, energy bars/nutritional bars, granolas, pre-cooked ready-made rice products, rice flour products, millet and sorghum products, plant based drinks and nut based drinks, pre-cooked rice and rice products, raw or pre-cooked noodles and pasta products),
Dairy based products (e.g. fruit or flavored yoghurts, ice creams, fruit ices, frozen desserts, fresh cheeses, soft cheeses, hard cheeses, milk drinks, wheys, butters, partially or wholly hydrolysed milk protein-containing products, fermented milk products, condensed milks and analogues),
Dairy analogues (imitation dairy products) also called dairy imitation containing non-dairy ingredients (plant-based proteins, vegetable fats, tofu product),
Confectionary products (e.g. filings, toppings, chewing gums, hard and soft candies),
Chocolate and coating products (e.g. chocolates, chocolate filings, spreads and coverture product containing sugar and/or cocoa butter and/or vegetable oil(s)),
Products based on fat and oil or emulsions thereof (e.g. mayonnaises, spreads, regular or low fat margarines, butter/margarine blends, flavored oils, shortenings, remoulades, dressings, salad dressings, spice preparations, peanut butters),
Eggs or egg products (dried eggs, egg whites, egg yolks, custards),
Desserts (e.g. gelatins, puddings, plant-based dessert, dessert creams),
Products made of soya protein or other soya bean fractions (e.g. soya milk and products made therefrom, soya lecithin-containing preparations, fermented products such as tofu or tempeh or products manufactured therefrom, soya sauces),
High protein foodstuff such as meat imitation products, quorn type of products, vegetal patties,
Vegetable preparations (e.g. ketchups, sauces, processed and reconstituted vegetables, dried vegetables, deep frozen vegetables, pre-cooked vegetables, vegetables pickled in vinegar, vegetable concentrates or pastes, cooked vegetables, potato preparations, vegetable juices),
Fruit preparations or processed fruits (e.g. jams, jellies, marmalades, canned fruits, fruit juices, fruit filling),
Vegetarian meat analogues or meat replacers, vegetarian burgers,
Spices or spice preparations (e.g. mustard preparations, horseradish preparations, pickles), spice mixtures and, in particular seasonings which are used, for example, in the field of snacks,
Snack articles (e.g. baked or fried potato crisps or potato dough products, bread dough products, popcorns, nuts, cereals, pulses and seeds, coated nuts, coated pulses, coated cereal extrudates based on maize, rice or ground nuts),
Ready dishes (e.g. instant noodles, rice, pastas, pizzas, tortillas, wraps) and soups and broths (e.g. stock, savory cubes, dried soups, instant soups, pre-cooked soups, retorted soups), sauces (instant sauces, dried sauces, ready-made sauces, gravies, sweet sauces, a relish sauces, a sour sauces),
oral care product, such as toothpastes, mouth washes, dental care products (e.g. denture adhesives), dental rinsing, mouth sprays, dental powders, dental gels or dental floss,
granulated sugars such as flavored sugars, sweeteners, blends of sugar and sweetner, flavored sweetners,
dietary supplements (e.g. products based on vitamins, minerals, amino acids, fatty acids, prebiotics or botanical extracts),
pharmaceutical products,
pet or animal food.

Preferably, the flavored consumer product may be baked goods, dairy based products, dairy analogues, products based on fat and oil or emulsions thereof, milk products, confectionary products, desserts, chocolate and compound coatings, cereal products, non-alcoholic beverages, alcoholic beverages, sugar syrup or instant or ready-to-drink beverages.

Preferably, the flavored consumer product may be covertures and filling, products based on sugars, breads, dry biscuits, cakes, rice cakes, rice crackers, cookies, crackers, donuts, muffins, pastries, pre-mixes, filings, toppings, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cocoa and products thereof, tea-based drinks, coffee-based drinks, cocoa-based drinks, infusions, syrups, chewing gums, hard and soft candies, fruit juices, frozen fruits, frozen fruit juices, water-based ices, fruit ices, sorbets, breakfast cereals, cereal bars, energy bars/nutritional bars, granolas, pre-cooked ready-made rice products, toppings, and syrups, including chocolate, berry, fruit, corn syrup, and maple sweet sauces and toppings, rice flour products, millet and sorghum products, raw or pre-cooked noodles, pasta products, meat imitation products and quorn type of products.

Some of the above-mentioned flavored consumer products may represent an aggressive medium for the invention's composition, so that it may be necessary to protect the invention's composition from premature decomposition, for example by encapsulation.

The proportions in which the invention's composition can be incorporated into the various of the aforementioned products vary within a wide range of values. These values are dependent on the nature of the consumer product to be flavored and on the desired organoleptic effect as well as the nature of the co-ingredients in a given base when the composition according to the invention are mixed with flavoring ingredients, solvents or additives commonly used in the art.

For example, in the case of flavored consumer product, typical concentrations are in the order of 0.001 ppm to 40000 ppm, more preferably, 0.005 ppm to 20000 ppm, even more preferably 0.01 ppm to 10000 ppm, of the invention's composition based on the weight of the consumer product into which they are incorporated.

Another object of the present invention is a method to reduce, limit, inhibit or suppress off-flavor of a flavoring composition or of a flavored article, which method comprises adding to said composition or article an effective amount of invention's flavor composition. In particular, the consumer products may be of a protein-based foodstuff, vegetable drinks, imitation dairies, cereal products such as bakery, breakfast and snack, or non-alcoholic beverages.

Another object of the present invention is the use of invention's flavor composition to reduce, limit, inhibit or suppress off-flavor in consumer products.

Another object of the present invention is a method to confer, enhance, improve or modify the flavor properties of a flavored article or to reduce, limit, inhibit or suppress off-flavor in a flavored article, which method comprises adding to said article an effective amount of composition as defined above.

### EXAMPLES

The invention will now be described in further detail by way of the following examples which illustrate the benefits and advantages of the present invention. The abbreviations have the usual meaning in the art, the temperatures are indicated in degrees centigrade (° C.)

### Example 1

### Invention's Flavor Composition

a) Flavor composition comprising ingredients capable of imparting a characteristic flavor note associated with phenolic note, brown flavors note, dairy note, honey and botanicals notes and fruits note

| Ingredients | Amount (%) | Notes |
|---|---|---|
| 2-methoxy-4-(2-propen-1- | 0.0001-0.001 | Phenolic |
| yl)phenol | | |
| 4-methyl-phenol | 0.00001-0.00005 | Phenolic |
| 2-methyl-propanal | 0.00001-0.00005 | Brown |
| 3-methyl-butanal | 0.0001-0.001 | Brown |
| 2-methyl-butanal | 0.0001-0.001 | Brown |
| benzaldehyde | 0.0001-0.001 | Brown |
| 2-furancarboxaldehyde | 0.00001-0.00005 | Brown |
| 4-methyl-2-phenyl-2-pentenal | 0.0001-0.001 | Brown |
| alpha-(3-methylbutylidene)- | 0.0001-0.001 | Brown |
| benzeneacetaldehyde | | |
| 1-(2-furanyl)-ethanone | 0.00001-0.00005 | Brown |
| 2,3,5(6)-trimethylpyrazine | 0.0001-0.001 | Brown |
| 2,5-dimethylpyrazine | 0.001-0.01 | Brown |
| 2-ethyl-3-methyl-pyrazine | 0.0001-0.001 | Brown |
| 2-ethyl-3,5-dimethylpyrazine | 0.0001-0.001 | Brown |
| Tetramethylpyrazine | 0.001-0.01 | Brown |
| Methylpyrazin | 0.00001-0.0001 | Brown |
| 3-methylbutanoic acid | 0.00001-0.00005 | Dairy |
| 2-methyl-propanoic acid | 0.001-0.01 | Dairy |
| benzene acetic acid | 0.01-0.1 | Honey & botanicals |
| phenyl acetaldehyde | 0.0001-0.001 | Honey & botanicals |
| 1-phenyl-ethanone | 0.0001-0.001 | Honey & botanicals |
| 2-(5-ethenyl-5-methyloxolan- | 0.0001-0.001 | Honey & botanicals |
| 2-yl)propan-2-ol | | |
| 2-methyl-butanoic acid | 0.001-0.01 | Fruits |
| Hexanoic acid | 0.001-0.01 | Fruits |
| 2-hydroxy-4- | 0.001-0.005 | |
| methoxybenzaldehyde | | |

To this composition, favoring co-ingredients an favor carriers were added up to 100%.
b) Flavor composition comprising ingredients capable of imparting a characteristic flavor note associated with phenolic note, brown flavors note, dairy note, honey and botanicals note and fruits note

| Ingredients | Amount (%) | Notes |
|---|---|---|
| 2-methoxy-4-(2-propen-1- | 0.0001-0.001 | Phenolic |
| yl)phenol | | |
| 3-methyl-butanal | 0.001-0.01 | Brown |
| 2-methyl-butanal | 0.001-0.01 | Brown |
| 3-hydroxy-2-methyl-4H- | 0.001-0.01 | Brown |
| pyran-4-one | | |
| 2-furanmethanol | 0.001-0.01 | Brown |
| 2,3,5(6)-trimethylpyrazine | 0.001-0.01 | Brown |
| 2,5-dimethylpyrazine | 0.001-0.01 | Brown |
| tetramethylpyrazine | 0.001-0.01 | Brown |
| 1-(2-pyrrolyl)-1-ethanone | 0.001-0.01 | Brown |
| 5,6-dihydro-6-pentyl-2H- | 0.001-0.01 | Brown |
| pyran-2-one | | |
| 3-methylbutanoic acid | 0.01-0.1 | Dairy |
| 2-methyl-propanoic acid | 0.001-0.01 | Dairy |
| benzenethanol | 0.001-0.01 | Honey & Botanicals |
| Benzene acetic acid | 0.01-0.1 | Honey & Botanicals |
| 3-phenyl-2-propenoic acid | 0.001-0.01 | Honey & Botanicals |
| 1-phenyl-ethanone | 0.0001-0.001 | Honey & Botanicals |
| 2,3-dimethylpyrazine | 0.0001-0.001 | Honey & Botanicals |
| 2-methyl-butanoic acid | 0.001-0.01 | Fruits |
| Hexanoic acid | 0.001-0.01 | Fruits |
| 2-hydroxy-4- | 0.002-0.003 | |
| methoxybenzaldehyde | | |

To this composition, flavoring co-ingredients and flavor carriers were added up to 100%.
c) Flavor composition comprising ingredients capable of imparting a characteristic flavor note associated with phenolic note, brown flavors note and honey and botanicals notes

| Ingredients | Amount (%) | Notes |
|---|---|---|
| 4-methoxybenzaldehyde | 0.0001-0.001 | Phenolic |
| 2-furancarboxaldehyde | 0.01-0.1 | Brown |
| 5-methyl-2- | 0.0001-0.001 | Brown |
| furancarboxaldehyde | | |
| benzene acetaldehyde | 0.01-0.1 | Honey & Botanicals |
| benzenethanol | 0.0001-0.001 | Honey & Botanicals |
| 2-hydroxy-4- | 0.001-0.01 | |
| methoxybenzaldehyde | | |

To this composition, flavoring co-ingredients and flavor carriers were added up to 100%.
d) Flavor composition comprising ingredients capable of imparting a characteristic flavor note associated with brown flavor note and dairy and meaty notes

| Ingredients | Amount (%) | Notes |
|---|---|---|
| 3-hydroxy-2-butanone | 0.5-5 | Dairy and Meaty |
| 2,3-pentanedione | 0.5-5 | Dairy and Meaty |
| Decanoic acid | 0.01-1 | Dairy and Meaty |
| Dodecanoic acid | 0.005-0.1 | Dairy and Meaty |
| Butanoic acid | 0.5-10 | Dairy and Meaty |
| Tetrahydro-6-pentyl-2H- | 0.5-10 | Dairy and Meaty |
| pyran-2-one | | |
| 6-heptyltetrahydro-2H- | 0.5-10 | Dairy and Meaty |
| pyran-2-one | | |
| Bis(2-methyl-3- | 0.0001-0.0005 | Dairy and Meaty |
| furyl)disulfide | | |
| 4-hydroxy-2,5-dimethyl-3- | 0.5-10 | Brown |
| furanone | | |
| 6-butyltetrahydro-2H- | 0.01-1 | Brown |
| pyran-2-one | | |
| 2-hydroxy-4- | 0.001-0.05 | |
| methoxybenzaldehyde | | |

To this composition, flavoring co-ingredients and flavor carriers were added up to 100%.
e) Flavor composition comprising ingredients capable of imparting a characteristic flavor note associated with brown flavor note, phenolic note and dairy note

| Ingredients | Amount (%) | Notes |
|---|---|---|
| 3-hydroxy-2-butanone | 0.01-1 | Dairy and Meaty |
| 2,3-pentanedione | 0.005-0.1 | Dairy and Meaty |
| Decanoic acid | 0.5-10 | Dairy and Meaty |
| Dodecanoic acid | 0.01-1 | Dairy and Meaty |
| Octanoic acid | 0.01-1 | Dairy and Meaty |
| Tetrahydro-6-pentyl-2H- | 0.01-1 | Dairy and Meaty |
| pyran-2-one | | |
| 4-methoxybenzaldehyde | 0.005-0.1 | Phenolic |
| 2-methoxyphenol | 0.01-1 | Phenolic |
| 4-hydroxy-3-methoxy- | 5-25 | Phenolic |
| Benzaldehyde | | |
| Benzaldehyde | 0.01-1 | Brown |
| 5,6-dihydro-6-pentyl-2H- | 0.001-0.1 | Brown |
| pyran-2-one | | |
| alpha-(3- | 0.001-0.1 | Brown |
| methylbutylidene)- | | |
| benzeneacetaldehyde | | |
| Decalepis Hamiltonii | 10-20 | |
| extract¹⁾ | | |

1) Extract Comprising about 0.67% of 2-Hydroxy-4-Methoxybenzaldehyde

To this composition, flavoring co-ingredients and flavor carriers were added up to 100%.
f) Flavor composition comprising ingredients capable of imparting a characteristic flavor note associated with fruit note and alcoholic beverages note

| Ingredients | Amount (%) | Notes |
|---|---|---|
| Octanal | 0.0001-0.5 | Fruit |
| cis-3-hexenol | 0.01 à 0.5 | |
| Orange peel extract | 0.5-10 | Alcoholic beverage |

To this composition, flavoring co-ingredients and flavor carriers were added up to 100%.
g) Flavor composition comprising ingredients capable of imparting a characteristic flavor note associated with brown note

| Ingredients | Amount (%) | Notes |
|---|---|---|
| 3-hydroxy-2-methyl-4H-pyran-4-one | 0.01-1 | Brown |

To this composition, flavoring co-ingredients and flavor carriers were added up to 100%.
h) Flavor composition comprising ingredients capable of imparting a characteristic flavor note associated with brown flavor note, phenolic note, honey and botanical notes, alcoholic beverages note and dairy note

| Ingredients | Amount (%) | Notes |
|---|---|---|
| Cocoa extract | 0.01-1 | Brown |
| Benzaldehyde | 0.01-1 | Brown |
| 4-hydroxy-2,5-dimethyl-3-furanone | 0.01-1 | Brown |
| 3-methylbutanal | 0.0001-0.01 | Brown |
| 2-hydroxy-3-methyl-2- | 0.001-0.1 | Brown |
| cyclopenten-1-one | | |
| 5,6-dihydro-6-pentyl-2H-pyran- | 0.001-0.1 | Brown |
| 2-one | | |
| 1,3-benzodioxole-5- | 0.01-1 | Phenolic |
| carbaldehyde | | |
| 4-methoxybenzaldehyde | 0.001-0.1 | Phenolic |
| Benzoin extract | 0.01-1 | Phenolic |
| 2-methoxy-4-methyl-phenol | 0.01-1 | Phenolic |
| 2-methoxyphenol | 0.001-0.1 | Phenolic |
| peru balsam extract | 0.00001-0.00005 | Phenolic |
| 2-methoxy-4-(2-propen-1- | 0.0001-0.0005 | Phenolic |
| yl)phenol | | |
| 3-hydroxy-2-butanone | 0.01-1 | Dairy |
| 2,3-pentanedione | 0.01-1 | Dairy |
| Decanoic acid | 0.01-1 | Dairy |
| Dodecanoic acid | 0.01-1 | Dairy |
| Hexanal | 0.001-0.1 | Honey |
| 2-hydroxy-4-methoxybenzaldehyde | 0.001-0.01 | |

To this composition, flavoring co-ingredients and flavor carriers were added up to 100%.
i) Flavor composition comprising ingredients capable of imparting a characteristic flavor note associated with brown note and sweetener

| Ingredients | Amount (%) | Notes |
|---|---|---|
| 4-hydroxy-2,5-dimethyl-3-furanone | 0.01-0.1 | Brown |
| Maple bark extract | 0.0001-0.0005 | Brown |
| Glucosylated steviol glycosides | 10-50 | Sweetener |
| Rebaudioside A | 40-70 | Sweetener |

To this composition, flavoring co-ingredients and flavor carriers were added up to 100%.
j) Flavor composition comprising ingredients capable of imparting a characteristic flavor note associated with alcoholic beverages note

| Ingredients | Amount (%) | Notes |
|---|---|---|
| Orange peel extract | 5-20 | Alcoholic beverage |

To this composition, flavoring co-ingredients and flavor carriers were added up to 100%.
k) Flavor composition comprising ingredients capable of imparting a characteristic flavor note associated with fruits note, dairy note and alcoholic beverages note

| Ingredients | Amount (%) | Notes |
|---|---|---|
| (3E)-4-(2,6,6-trimethyl-1- | 0.5-10 | Fruit |
| cyclohexen-1-yl)-3-buten-2-one | | |
| (E)-4-(2,6,6-trimethyl-1- | 0.01-1 | Fruit |
| cyclohex-2-enyl)but-3-en-2-one | | |
| Hexanoic acid | 0.5-10 | Fruit |
| cis-3-hexenyl acetate | 0.01-1 | Fruit |
| ethyl acetate | 0.01-1 | Fruit |
| 2-hexenal | 0.01-1 | Fruit |
| 3-hydroxy-2-butanone | 0.01-1 | Dairy |
| Tetrahydro-6-pentyl-2H-pyran-2-one | 0.01-1 | Dairy |
| 2-heptanone | 0.01-1 | Dairy |
| (−)-(1R,4E,9S)-4,11,11-trimethyl-8- | 0.01-1 | Alcoholic beverage |
| methylenebicyclo[7.2.0]undec-4-ene | | |
| 2-hydroxy-4-methoxybenzaldehyde | 0.001-0.01 | |

To this composition, flavoring co-ingredients and flavor carriers were added up to 100%.
l) Flavor composition comprising ingredients capable of imparting a characteristic flavor note associated with alcoholic beverages note, brown note, phenolic note, fruits note, dairy note and honey and botanicals notes

| Ingredients | Amount (%) | Notes |
|---|---|---|
| Oakwood extracts | 1-10 | Alcoholic |
| ethyl ester dodecanoic acid | 0.1-1 | Alcoholic |
| Cognac oil green | 0.001-0.01 | Alcoholic |
| 2-furancarboxaldehyde | 0.01-0.1 | Brown |
| vanilla extract | 0.1-1 | Phenolic |
| 1-pentanol | 1-10 | Fruits |
| ethyl ester octanoic acid | 0.1-1 | Fruits |
| ethyl ester decanoic acid | 0.1-1 | Fruits |
| (2E)-1-(2,6,6-trimethyl-1,3- | 0.0001-0.001 | Fruits |
| cyclohexadien-1-yl)-2-buten-1-one | | |
| decanoic acid | 0.1-1 | Dairy |
| dodecanoic acid | 0.01-0.1 | Dairy |
| octanoic acid | 0.01-0.1 | Dairy |
| benzenethanol | 0.1-1 | Honey & Botanicals |
| 2-hydroxy-4-methoxybenzaldehyde | 0.00001-0.0001 | |

To this composition, flavoring co-ingredients and flavor carriers were added up to 100%.
m) Flavor composition comprising ingredients capable of imparting a characteristic flavor note associated with alcoholic beverages note, brown note, phenolic note, honey & botanicals notes and fruits note

| Ingredients | Amount (%) | Notes |
|---|---|---|
| Oakwood extracts | 30-60 | Alcoholic |
| Ethyl ester dodecanoic acid | 0.01-0.1 | Alcoholic |
| 4-hydroxy-2,5-dimethyl-3- | 0.01-0.1 | Brown |
| furanone | | |
| 2-hydroxy-3-methyl-2- | 0.001-0.01 | Brown |
| cyclopenten-1-one | | |
| 5,6-dihydro-6-pentyl-2H- | 0.01-0.1 | Brown |
| pyran-2-one | | |
| 4-methoxybenzaldehyde | 0.01-0.1 | Phenolic |
| 2-methoxy-4-(2-propen-1- | 0.001-0.01 | Phenolic |
| yl)phenol | | |
| 1,3-benzodioxole-5- | 0.001-0.01 | Phenolic |
| carbaldehyde | | |
| 5-butyldihydro-2(3H)- | 0.01-0.1 | Honey & Botanicals |
| furanone | | |
| 3-phenyl-2-propenoic acid | 0.01-0.1 | Honey & Botanicals |
| (3E)-4-(2,6,6-trimethyl-1- | 0.01-0.1 | Fruits |
| cyclohexen-1-yl)-3-buten-2-one | | |
| Decalepis Hamiltonii extract¹⁾ | 5-10 | |

1) Extract comprising about 0.67% of 2-hydroxy-4-methoxybenzaldehyde

To this composition, flavoring co-ingredients and flavor carriers were added up to 100%.
n) Flavor composition comprising ingredients capable of imparting a characteristic flavor note associated with alcoholic beverage not, brown note, fruits note, dairy note and honey and botanicals notes

| Ingredients | Amount (%) | Notes |
|---|---|---|
| Oakwood extracts | 1-10 | Alcoholic |
| ethyl ester dodecanoic acid | 0.05-0.25 | Alcoholic |
| Cognac oil green | 0.005-0.025 | Alcoholic |
| 2-furancarboxaldehyde | 0.01-0.1 | Brown |
| 1-pentanol | 1-10 | Fruits |
| ethyl ester octanoic acid | 0.05-0.3 | Fruits |
| ethyl ester decanoic acid | 0.1-1 | Fruits |
| (2E)-1-(2,6,6-trimethyl-1,3- | 0.0001-0.001 | Fruits |
| cyclohexadien-1-yl)-2-buten-1-one | | |
| decanoic acid | 0.02-0.2 | Dairy |
| 3-methylbutanoic acid | 0.07-0.4 | Dairy |
| octanoic acid | 0.01-0.1 | Dairy |
| benzenethanol | 0.01-0.1 | Honey & Botanicals |
| 2-hydroxy-4-methoxybenzaldehyde | 0.00004-0.0001 | |

To this composition, flavoring co-ingredients and flavor carriers were added up to 100%.
o) Flavor composition comprising ingredients capable of imparting a characteristic flavor note associated with dairy note, phenolic note and brown note

| Ingredients | Amount (%) | Notes |
|---|---|---|
| 3-hydroxy-2-butanone | 0.1-1 | Dairy |
| 2,3-pentanedione | 0.01-0.1 | Dairy |
| octanoic acid | 0.1-1 | Dairy |
| decanoic acid | 0.3-1.3 | Dairy |
| dodecanoic acid | 0.5-3 | Dairy |
| tetrahydro-6-pentyl-2H-pyran-2-one | 0.01-0.1 | Dairy |
| 4-methoxybenzaldehyde | 0.001-0.01 | Phenolic |
| 2-methoxyphenol | 0.01-0.1 | Phenolic |
| benzaldehyde | 0.01-0.1 | Brown |
| 5,6-dihydro-6-pentyl-2H-pyran-2-one | 0.001-0.01 | Brown |
| 2-hydroxy-4-methoxybenzaldehyde | 0.01-0.1 | |

To this composition, flavoring co-ingredients and flavor carriers were added up to 100%.
p) Flavor composition comprising ingredients capable of imparting a characteristic flavor note associated with dairy note, phenolic note and brown note

| Ingredients | Amount (%) | Notes |
|---|---|---|
| 3 -hydroxy-2-butanone | 0.1-1 | Dairy |
| tetrahydro-6-pentyl-2H-pyran-2-one | 0.01-0.1 | Dairy |
| 1,3-benzodioxole-5-carbaldehyde | 0.1-1 | Phenolic |
| 4-methoxybenzaldehyde | 0.001-0.01 | Phenolic |
| 2-methoxyphenol | 0.01-0.1 | Phenolic |
| benzaldehyde | 0.01-0.1 | Brown |
| 2-hydroxy-4-methoxybenzaldehyde | 0.005-0.05 | |

To this composition, flavoring co-ingredients and flavor carriers were added up to 100%.
q) Flavor composition comprising ingredients capable of imparting a characteristic flavor note associated with dairy note, phenolic note and brown flavors note

| Ingredients | Amount (%) | Notes |
|---|---|---|
| 3-hydroxy-2-butanone | 0.1-1 | Dairy |
| 2,3-pentanedione | 0.1-1 | Dairy |
| vanilla extract | 1-10 | Phenolic |
| fenugreek extract | 0.5-5 | Brown |
| cocoa extract | 0.3-3 | Brown |
| 2-furancarboxaldehyde | 0.2-21 | Brown |
| 2-hydroxy-3-methyl-2-cyclopenten-1-one | 0.2-2 | Brown |

To this composition, flavoring co-ingredients and flavor carriers were added up to 100%.
r) Flavor composition comprising ingredients capable of imparting a characteristic flavor note associated with dairy note, phenolic note and brown flavors note

| Ingredients | Amount (%) | Notes |
|---|---|---|
| 3-hydroxy-2-butanone | 0.1-1 | Dairy |
| butanoic acid | 0.1-1 | Dairy |
| 2,3-pentanedione | 0.01-0.1 | Dairy |
| vanilla extract | 1-10 | Phenolic |
| fenugreek extract | 1-10 | Brown |
| cocoa extract | 0.1-1 | Brown |
| 3-hydroxy-2-methyl-4H-pyran-4-one | 0.1-1 | Brown |
| 4-hydroxy-2,5-dimethyl-3-furanone | 0.1-1 | Brown |
| 2-hydroxy-3-methyl-2-cyclopenten-1-one | 0.1-1 | Brown |
| benzaldehyde | 0.01-0.1 | Brown |
| glucosylated steviol glycosides | 1-10 | Sweetener |

To this composition, flavoring co-ingredients and flavor carriers were added up to 100%.

### Example 2

Sensory Test of the Invention's Flavor Composition in Sugar Water

Samples A-C were prepared in 5% wt sugar water as shown in table 1.

TABLE 1
Compositions of samples A-C in 5% sugar water

| | | Amount of flavor |
|---|---|---|
| Sample | Flavor composition | composition (% wt) |
| A | Example 1 a) | 0.10 |
| B | Example 1 b) | 0.15 |
| C | Example 1 d) | 0.006 |

6 trained panelists tasted samples A-C which were presented as sugar water without any other explanation in a blind and randomized order. The panelists were asked to rate the intensities of selected descriptors. The long lastingness of sample A was improved by the addition of 2-hydroxy-4-methoxybenzaldehyde. The addition of 2-hydroxy-4-methoxybenzaldehyde to Sample B was masking cocoa-related off-notes like mushroom and rounding off woody and bitter notes. The addition of 2-hydroxy-4-methoxybenzaldehyde to Sample C gave more balance to the overall flavor profile.

### Example 3

Instant Coffee Comprising the Invention's Flavor Composition

TABLE 2
Compositions of instant coffee

| Ingredients | Amount (%) | Amount (%) | Amount (%) |
|---|---|---|---|
| Instant coffee powder | 1.0 | 1.0 | 1.0 |
| Sugar | 5.0 | 5.0 | 5.0 |
| Water | 94.0 | 94.0 | 94.0 |
| Flavor composition | 0.10 | 0 | 0 |
| of Example 1 a) | | | |
| Flavor composition | 0 | 1.15 | 0 |
| of Example 1 b) | | | |
| Flavor composition | 0 | 0 | 0.05 |
| of Example 1 c) | | | |

Instant coffee powder, sugar and the invention's flavor composition as mentioned in Table 2 were weighted into a glass beaker. Then water at a temperature of 80° C. was added. The obtained coffee was stirred 5 minutes and evaluated hot.

### Example 4

Invention's Composition in Consumer Products

a) Coffee with Milk and Flavored Syrup

TABLE 3
Composition of coffee sweetened with syrup

| Ingredients | Amount (g) |
|---|---|
| Coffee brewed | 70.19 g |
| Whole milk | 22.81 g |
| Sugar Syrup | 7.00 g |
| | 100.00 g |

TABLE 4
Composition of sugar Syrup

| Ingredients | Amount (g) | |
|---|---|---|
| Sodium Benzoate | 1.80 | g |
| Potassium Sorbate | 0.72 | g |
| Sugar | 650.0 | g |
| Citric Acid | 4.00 | g |
| Qs Water to | 1000.00 | g |

The sugar syrup was prepared by mixing sodium benzoate, potassium sorbate, sugar and citric acid in a glass beaker. Then, water was added until a total weight of 1000 g was reached. The invention's flavor composition as reported in Table 11 was added to the syrup.

The coffee brew was prepared by brewing 10 grams of coffee per 180 ml of water. The brewed coffee, the whole milk and the flavored sugar syrup were mixed as per the amounts indicated in Table 3 and evaluated hot.

b) Plant-Based Protein Drink

TABLE 5
Composition of plant based protein drink

| Ingredients | Amount % wt |
|---|---|
| Water | 94 |
| Pea Protein | 3 |
| Sugar | 3 |

The water was pre-heated until it reached 55° C. Sugar and pea protein were mixed and dispersed into water at a temperature of 55° C. using Ultra-Turax T50 dispersion tool at speed 2 for 10 min. The mixture obtained was pasteurized (Thermomix at 90° for 10 min at speed 2.5). The invention's flavor composition as reported in Table 11 was added to the pasteurized blend and cooled down to room temperature.

c) Sugar-Coated Nuts

TABLE 6
Composition of sugar-coated nuts

| Ingredients | Amount (% wt) |
|---|---|
| Water | 20% |
| Unpeeled almonds or other nuts | 40% |
| Sugar | 40% |

The water and sugar were added in a saucepan over medium heat until boiling. The nuts and the invention's flavor composition as reported in Table 11 were added. The mixture was cooked and stirred until the liquid evaporated and the almonds were well coated with the caramel. The almonds were poured onto a baking sheet lined with waxed paper and cooled down at room temperature.

d) Sugar Coated Cereals

TABLE 7
Composition of sugar syrup

| Ingredients | Amount (% wt) |
|---|---|
| Water | 37.5% |
| Sugar | 62.5% |
| | 100% |

TABLE 8
Composition of sugar coated cornflakes

| Ingredients | Amount (% wt) |
|---|---|
| 73° B sugar syrup of Table 7 | 47.92% |
| Corn flakes | 52.08% |

The sugar syrup was prepared by dissolving the sugar in water and boiling the to 730 brix. The cereals were loaded into the tumbler. The syrups and invention's flavor composition as reported in Table 11 were heated at a temperature around 50° C. under agitation. The flavored syrup was dropped within the heated tumbler at a temperature comprised between 45° C. and 50° C. through the peristatic pump. The coated cereals were cooled down at ambient temperature. After 1 hour the coated cereals were packed into plastic bags and sealed.

e) Milkshake

TABLE 9
Composition of a milkshake

| Ingredients | Amount (g) | |
|---|---|---|
| Whole milk pasteurized | 890 | g |
| White chocolate | 75 | g |
| Sugar | 3 | g |
| Emulsifier/slabilizer¹⁾ | 5 | g |
| | 1000 | g |

¹⁾Cremodan ® 809; trademark and origin: Danisco

Sugar, white chocolate and the emulsifier/stabilizer were mixed. To this mixture, the milk was added at 50° C. under agitation with Thermomix® speed 2 or 3. The mixture was stirred 5 minutes at 90° C. The invention's flavor composition as reported in Table 11 was added and the mixture was filled into bottles. The bottles were cooled down under agitation to 15 to 20° C. using a water bath and then kept in the fridge.

f) Cereal Bar

TABLE 10
Composition of a cereal bar

| Ingredients | Amount |
|---|---|
| Binding syup | 50 g |
| Oats | 16 g |
| Rice krispies | 16 g |
| Bran flakes | 18 g |

The invention's flavor composition as reported in Table 11 was incorporated into the binding syrup. This flavored binding syrup was mixed with the cereal blend, and cereal bars of about 40 g were formed.

g) Branched Chain Amino Acids (BCAA) Supplement

The invention's flavor composition as reported in Table 11 was mixed into a commercially available powder blend of branched chain amino acids (BCAA). 5 g of the powder obtained was then diluted in 250 ml of water.

h) Vodka (40% Alcohol by Volume (ABV))

To a vodka was added invention's flavor composition as reported in Table 11.

i) Alcoholic Beverage

Vodka was diluted with demineralized water down to 20% ABV. Then the invention's flavor composition as reported in Table 11 was added.

TABLE 11
Invention's composition in consumer products

| | Invention's flavor composition |
|---|---|
| Consumer Product | (wt % in the Consumer Product) |
| Coffee with flavored | Example 1a) (0.10%) |
| Syrup | |
| Coffee with flavored | Example 1b) (0.15%) |
| Syrup | |
| Coffee with flavored | Example 1c) (0.05%) |
| Syrup | |
| Plant-based protein | Example 1 e) (0.005 to 0.030) |
| drink | |
| Sugar-coated nuts | Example 1d) (0.018%) |
| Coated cornflakes | Example 1d) (0.018%) |
| Milkshake | Example 1k) (0.02%) |
| Cereal bar | Example 1c) (0.05%) |
| Branched chain | Example 1f) (0.08%); Example 1g) (0.01%); |
| amino acid (BCAA) | Example 1h) (0.008%) and Example 1i) (0.029%) |
| supplement | |
| Branched chain | Example 1e) (0.005%); Example 1q) |
| amino acid (BCAA) | (0.06%) and Example 1r) (0.06%) |
| supplement | |
| Branched chain | Example 1j) (0.08%); Example 1g) (0.01%); |
| amino acid (BCAA) | Example 1h) (0.008%) and Example 1i) (0.029%) |
| supplement | |
| Vodka (40% ABV) | Example 1m) (0.05%) |
| Alcoholic beverage | Example 1l) (0.10%) |
| (20% ABV) | |
| Alcoholic beverage | Example 1n) (0.10%) |
| (20% ABV) | |
| Plant-based protein | Example 1 o) (0.005 to 0.030) |
| drink | |
| Plant-based protein | Example 1 p) (0.005 to 0.030) |
| drink | |
| Plant-based protein | Example 1 h) (0.005 to 0.030) |
| drink | |

The use of the invention's flavor composition in a consumer product allowed to obtain a more long-lasting and round organoleptic profile. For plant-based protein drink and Branched chain amino acid (BCAA) supplement, the addition of the invention's flavor composition allowed reducing the perception off-notes.

1. A flavor composition comprising
i) 2-hydroxy-4-methoxybenzaldehyde; and
ii) at least one or more ingredients capable of imparting a characteristic flavor note associated with
a. phenolic note;
b. dairy and meaty notes;
c. brown flavors note;
d. honey and botanicals notes;
e. fruits note,
f. alcoholic beverages note;
and/or
iii) at least one ingredient selected from the list of sweetener, trigeminal sensates or taste modulators.

2. The flavor composition according to claim 1, wherein the ingredients capable of imparting a characteristic flavor note associated with phenolic note are selected from the group consisting of phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 4-ethenylphenol, 2-ethoxy-5-(1-propenyl)phenol, 4-methoxybenzaldehyde, 4-methoxy-benzenemethanol, 4-methoxy-benzoic acid, 1,3-benzodioxole-5-carbaldehyde, 4-methoxybenzyl acetate, (4-methoxyphenyl) methyl formate, methyl 2-hydroxy-4-methoxybenzoate, 4-hydroxy-benzenemethanol, 2,6-dimethoxy-phenol, 4-hydroxy-3-methoxybenzyl alcohol, 4-hydroxy-3-methoxybenzyl acetate, 4-hydroxy-3-methoxybenzyl acid, 4-(ethoxymethyl)-2-methoxyphenol, (E)-1-(4-methoxy-1-phenyl)-1-penten-3-one, 2-methyl-phenol, 1,2-dimethoxy-4-methylbenzene, vanilla extract, benzoin extract, peru balsam extract, tolu extract, guaiacwood oil, 3,4-dimethoxy-benzaldehyde, 3-ethoxy-4-hydroxybenzaldehyde, 4-(4-methoxyphenyl)-2-butanone, 3-hydroxy-2-methoxybenzaldehyde, 3-hydroxy-5-methoxybenzaldehyde, 2-hydroxy-3-methoxybenzaldehyde, 2-hydroxy-5-methoxybenzaldehyde, 3-hydroxy-4-methoxybenzaldehyde, 4-hydroxy-2-methoxy-benzaldehyde, 2,4-dimethoxy-benzaldehyde, 2,4-diethoxy-benzaldehyde, 2,4-dimethoxy-6-methyl-benzaldehyde, 5-ethoxy-2-hydroxy-benzaldehyde, 5-hydroxy-2-methoxy-benzaldehyde, 2,6-dimethoxy-4-methylbenzaldehyde, 2-methoxy-4-(methoxymethyl)phenol, 4-(methoxymethyl)phenol, 4-hydroxybenzaldehyde, 4-methoxy-methyl ester benzoic acid, 4-hydroxybenzoic acid, methyl 4-hydroxy-3-methoxybenzoate, ethyl 4-hydroxy-3-methoxybenzoate, 4-hydroxy-3-methoxybenzoic acid, 4-hydroxy-3,5-dimethoxy-benzaldehyde, ethyl ester 4-methoxy benzoic acid and a combination thereof.

3. The flavor composition according to claim 1, wherein the ingredients capable of imparting a characteristic flavor note associated with dairy and meaty notes are selected from the group consisting of decanoic acid, butanoic acid, 2-methylpropanoic acid, 6-heptyltetrahydro-2H-pyran-2-one, 3-hydroxy-2-butanone, 2,3-pentanedione, 5-pentylfuran-2(5H)-one, tetrahydro-6-pentyl-2H-pyran-2-one, 6-heptyltetrahydro-2H-pyran-2-one, dihydro-2(3H)-furanone, 3-methyl-butanoic acid, decenoic acid, dodecanoic acid, tetradecanoic acid, hexadecanoic acid, octadecanoic acid, (Z)-9-octadecenoic acid, 2-decanone, 2-heptanone, 3-heptanone, ethyl lactate, acid octanoic, dairy extracts and processed dairy products, 2-methyl-3-furanthiol, bis(2-methyl-3-furyl)disulfide, (E)-2-nonenal and a combination thereof.

4. The flavor composition according to claim 1, wherein the ingredients capable of imparting a characteristic flavor note associated with brown flavors note are selected from the group consisting of 3-methylbutanal, cocoa extract, 2-furanmethanol, 2-furancarboxaldehyde, 5-methyl-2-furancarboxaldehyde, 4-hydroxy-2,5-dimethyl-3-furanone, 2-ethyl-3-hydroxy-4H-pyran-4-one, 3-hydroxy-2-methyl-4H-pyran-4-one, brown sugar extract, cane sugar extract, tetramethylpyrazine, 2-methyl-propanal, 2-methyl-butanal, 2-acetyl-1-pyrroline, 2-acetyl-2-pyrroline, 2-acetyltetrahydropyridine, 2-acetyl-3,4,5,6-tetrahydropyridine, 2-acetyl-1,4,5,6-tetrahydropyridine, pyrrolidine, methylpyrazine, 2-ethyl-6-methylpyrazine, 2,3,5(6)-trimethylpyrazine, 2,5-dimethylpyrazine, 2,6-dimethylpyrazine 2-acetylpyridine, methyl tetrahydrofuranone, 1-(2-furanyl)-ethanone, 2-ethyl-5-methylpyrazine, 2-ethyl-6-methylpyrazine, 1-(2-pyrrolyl)-1-ethanone, 2-isopropyl-5-methylhexanal, 2-isopropyl-5-methyl-2-hexenal, 4-methyl-2-phenyl-2-pentenal, alpha-(3-methylbutylidene)-benzeneacetaldehyde, 1-(thiazol-2-yl)ethan-1-one, 2-furanmethanthiol, 1-(3-methylpyrazinyl)-ethanone, 2-ethyl-3-methyl-pyrazine, 2-((methyldithio)methyl)-furan, 1-(4,5-dihydro-1,3-thiazol-2-yl)-1-ethanone, 2,5-dihydro-4,5-dimethyl-2-(2-methylpropyl)-thiazole, dihydro-2,4,6-tris(2-methylpropyl)-4H-1,3,5-dithiazine, 2-decenal, benzaldehyde, massoia bark extracts, Tonka bean extract, fenugreek extracts, 5,6-dihydro-6-pentyl-2H-pyran-2-one, dihydro-5-pentyl-2(3H)-furanone, tetrahydro-6-pentyl-2H-pyran-2-one, 1,4-dimethoxy-benzene, 6-methyl-2H-1-benzopyran-2-one, 3,4-dihydro-2H-1-benzopyran-2-one, 1-benzopyran-2-one, 3-hydroxy-4,5-dimethyl-2(5H)-furanone, tetrahydro-6-propyl-2H-pyran-2-one, 6-butyltetrahydro-2H-pyran-2-one, 5-butyldihydro-2(3H)-furanone, 5-propyldihydro-2(3H)-furanone, 5-methyldihydro-2(3H)-furanone, 2,4-decadienal, 1-(pyrazin-2-yl)ethan-1-one, 5-methylhept-2-en-4-one, 2-hydroxy-3-methyl-2-cyclopenten-1-one, 3,4-dimethyl-1,2-cyclopentanedione, 3-ethyl-2,5-dimethylpyrazine, 2-ethyl-3,5-dimethylpyrazine, 6,7-dihydro-5-methyl-5H-cyclopentapyrazine, 2-ethylpyrazine, 2-methoxy-3-(1-methylethyl)-pyrazine, 2-ethyl-3-methoxy-pyrazine, 2-methoxy-3-methyl-pyrazine, 2-methoxy-5-methyl-pyrazine, 2-methylthio-3-methylpyrazine, 2-methylthio-5-methylpyrazine, 2-methylthio-6-methylpyrazine, and a combination thereof.

5. The flavor composition according to claim 1, wherein the ingredients capable of imparting a characteristic flavor note associated with honey and botanicals notes are selected from the group consisting of 2-hydroxybenzaldehyde, beeswax extracts, phenylacetaldehyde, hexahydro-3,6-dimethyl-2(3H)-benzofuranone, 1-(2-hydroxy-4-methoxyphenyl) ethanone, 5-methyl-2(3H)-furanone, methyl 2-hydroxybenzoate, 1-octen-3-ol, 1-octen-3-one, 3-buten-2-one, 3-methyl-3-buten-2-one, hexanal, heptanal, 2,6-nonadienal, 1-phenyl-ethanone, 2,3-dimethylpyrazine, benzene ethanol, benzene acetic acid, methyl ester (9Z,12Z,15Z)-9,12,15-Octadecatrienoic acid, mate extract, honey extracts, tea extracts, 2-(5-ethenyl-5-methyloxolan-2-yl)propan-2-ol, ginger extract, mint oil, benzoic acid phenylmethyl ester, 3-phenyl-2-propenal, 3-phenyl-2-propen-1-ol, 3-phenyl-2-propenoic acid, hay extract, flouve extract, ethyl ester benzenepropanoic acid, methyl benzoate and a combination thereof.

6. The flavor composition according to claim 1, wherein the ingredients capable of imparting a characteristic flavor note associated with fruits note are selected from the group consisting of ethyl 3-phenyl-2-propenoate, methyl 3-phenyl-2-propenoate, ethyl ester benzoic acid, Methyl ester benzoic acid, 5-hexyldihydro-2(3H)-furanone, 5-ethyldihydro-2(3H)-furanone, 6-hexyltetrahydro-2H-pyran-2-one, 5-heptyldihydro-2(3H)-furanone, 5-octyldihydro-2(3H)-furanone, 6-methyltetrahydro-2H-pyran-2-one, 2-methyl-butanoic acid, hexanoic acid, 1-pentanol, 1-octanol, 1-hexanol, (2E)-1-(2,6,6-trimethyl-1,3-cyclohexadien-1-yl)-2-buten-1-one, ethyl vinyl ketone, octanal, pentanal, 2-heptenal, 2-butenal, 2-hexenal, (3E)-4-(2,6,6-trimethyl-1-cyclohexen-1-yl)-3-buten-2-one, (E)-4-(2,5,6,6-tetramethyl-1-cyclohex-2-enyl)but-3-en-2-one, (E)-4-(2,6,6-trimethyl-1-cyclohex-2-enyl)but-3-en-2-one, ethyl lactate, ethyl acetate, ethyl butanoate, cis-3-hexenol, cis-3-hexenyl acetate, cis-3-hexenyl butyrate, ethyl hexanoate, ethyl isovalerate, 2-amino-methyl ester benzoic acid, 2-amino-ethyl ester benzoic acid, 2-(methylamino)-methyl ester benzoic acid, ethyl ester 2-methyl butanoic acid, Ethyl ester octanoic acid, 1-butanol-3-methyl-acetate, 4-decenal, Ethyl ester propanoic acid, 1,1-diethoxy-ethane, 2-(methylamino)-methyl ester benzoic acid, ethyl heptanoate and a combination thereof.

7. The flavor composition according to claim 1, wherein the ingredients capable of imparting a characteristic flavor note associated with alcoholic beverages note are selected from the group consisting of (−)-(1R,4E,9S)-4,11,11-trimethyl-8-methylenebicyclo[7.2.0]undec-4-ene, oakwood extract, 5-butyldihydro-4-methyl-2(3H)-furanone, chicory extract, cinnamon bark extract, clove extract, cardamon extract, marjoram extract, savory extract, gentian extract, chichonna extract, quasia amara extract, juniper extract, coriander extract, cognac extract, star anise oil, licorice extract, orange peel extract, lemon peel extract, oregano extract, thyme extract, nutmeg extract, cassia extract, rum extract, whisky extract, brandy extract, 5-allyl-1,2,3-trimethoxybenzene, ethyl ester propanoic acid, ethyl ester 2-propenoic acid, ethyl ester 2-butenoic acid, ethyl ester decanoic acid, 4-oxo-ethyl ester pentanoic acid, ethyl ester nonanoic acid, ethyl tetradecanoate, ethyl ester 2-butenoic acid, ethyl octanoate, ethyl ester dodecanoic acid and a combination thereof.

8. The flavor composition according to claim 1 wherein the flavor composition comprises at least one ingredient capable of imparting characteristic flavor note associated with phenolic note and at least one ingredient capable of imparting characteristic flavor note associated with notes selected from the group consisting of dairy and meaty notes, brown flavors note, honey and botanicals notes, fruits notes and alcoholic beverages note.

9. The flavor composition according to claim 1, wherein the flavor composition comprises at least one, two or more ingredients capable of imparting characteristic flavor note associated with dairy and meaty notes and at least one ingredient capable of imparting characteristic flavor note associated with fruits note.

10. The flavor composition according to claim 1, wherein the flavor composition comprises at least one ingredient capable of imparting characteristic flavor note associated with fruits note and at least one ingredient capable of imparting characteristic flavor note associated with alcoholic beverages note.

11. A flavored consumer product comprising a composition as defined in claim 1.

12. The flavored consumer product according to claim 11, wherein the flavored consumer product is selected from the group consisting of a protein-based foodstuff, baked goods, dairy based products, dairy imitation, products based on fat and oil or emulsions thereof, milk products, confectionary products, desserts, chocolates, coatings products, cereal products, non-alcoholic beverages, alcoholic beverages or instant or ready-to-drink beverages, granulated sugars, egg products, gravies and sweet sauces.

13. The flavored consumer product according to claim 12, characterized in that the flavored consumer product is selected from the group consisting of covertures and filling, products based on sugars, breads, dry biscuits, cakes, rice cakes, rice crackers, cookies, crackers, donuts, muffins, pastries, pre-mixes, filings, toppings, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cocoa and products thereof, tea-based drinks, coffee-based drinks, cocoa-based drinks, infusions, syrups, chewing gums, hard and soft candies, frozen fruits, frozen fruit juices, water-based ices, fruit ices, sorbets, breakfast cereals, cereal bars, energy bars/nutritional bars, granolas, pre-cooked ready-made rice products, rice flour products, millet and sorghum products, raw or pre-cooked noodles, pasta products, meat imitation products and quorn type of products.

14. A method to confer, enhance, improve or modify the flavor properties of a flavored article, which method comprises adding to said article an effective amount of at least one composition as defined in claim 1.

15. A method to reduce, limit, inhibit or suppress off-flavor in a flavored article, which method comprises adding to said article an effective amount of at least one composition as defined in claim 1.

16. The flavor composition according to claim 9, wherein the ingredients capable of imparting a characteristic flavor note associated with dairy and meaty notes are selected from the group consisting of decanoic acid, butanoic acid, 2-methylpropanoic acid, 6-heptyltetrahydro-2H-pyran-2-one, 3-hydroxy-2-butanone, 2,3-pentanedione, 5-pentylfuran-2(5H)-one, tetrahydro-6-pentyl-2H-pyran-2-one, 6-heptyltetrahydro-2H-pyran-2-one, dihydro-2(3H)-furanone, 3-methyl-butanoic acid, decenoic acid, dodecanoic acid, tetradecanoic acid, hexadecanoic acid, octadecanoic acid, (Z)-9-octadecenoic acid, 2-decanone, 2-heptanone, 3-heptanone, ethyl lactate, acid octanoic, dairy extracts and processed dairy products, 2-methyl-3-furanthiol, bis(2-methyl-3-furyl)disulfide, (E)-2-nonenal and a combination thereof.

17. The flavor composition according to claim 9, wherein the ingredients capable of imparting a characteristic flavor note associated with fruits note are selected from the group consisting of ethyl 3-phenyl-2-propenoate, methyl 3-phenyl-2-propenoate, ethyl ester benzoic acid, Methyl ester benzoic acid, 5-hexyldihydro-2(3H)-furanone, 5-ethyldihydro-2(3H)-furanone, 6-hexyltetrahydro-2H-pyran-2-one, 5-heptyldihydro-2(3H)-furanone, 5-octyldihydro-2(3H)-furanone, 6-methyltetrahydro-2H-pyran-2-one, 2-methyl-butanoic acid, hexanoic acid, 1-pentanol, 1-octanol, 1-hexanol, (2E)-1-(2,6,6-trimethyl-1,3-cyclohexadien-1-yl)-2-buten-1-one, ethyl vinyl ketone, octanal, pentanal, 2-heptenal, 2-butenal, 2-hexenal, (3E)-4-(2,6,6-trimethyl-1-cyclohexen-1-yl)-3-buten-2-one, (E)-4-(2,5,6,6-tetramethyl-1-cyclohex-2-enyl)but-3-en-2-one, (E)-4-(2,6,6-trimethyl-1-cyclohex-2-enyl)but-3-en-2-one, ethyl lactate, ethyl acetate, ethyl butanoate, cis-3-hexenol, cis-3-hexenyl acetate, cis-3-hexenyl butyrate, ethyl hexanoate, ethyl isovalerate, 2-amino-methyl ester benzoic acid, 2-amino-ethyl ester benzoic acid, 2-(methylamino)-methyl ester benzoic acid, ethyl ester 2-methyl butanoic acid, Ethyl ester octanoic acid, 1-butanol-3-methyl-acetate, 4-decenal, Ethyl ester propanoic acid, 1,1-diethoxy-ethane, 2-(methylamino)-methyl ester benzoic acid, ethyl heptanoate and a combination thereof.

18. The flavor composition according to claim 10, wherein the ingredients capable of imparting a characteristic flavor note associated with fruits note are selected from the group consisting of ethyl 3-phenyl-2-propenoate, methyl 3-phenyl-2-propenoate, ethyl ester benzoic acid, Methyl ester benzoic acid, 5-hexyldihydro-2(3H)-furanone, 5-ethyldihydro-2(3H)-furanone, 6-hexyltetrahydro-2H-pyran-2-one, 5-heptyldihydro-2(3H)-furanone, 5-octyldihydro-2(3H)-furanone, 6-methyltetrahydro-2H-pyran-2-one, 2-methyl-butanoic acid, hexanoic acid, 1-pentanol, 1-octanol, 1-hexanol, (2E)-1-(2,6,6-trimethyl-1,3-cyclohexadien-1-yl)-2-buten-1-one, ethyl vinyl ketone, octanal, pentanal, 2-heptenal, 2-butenal, 2-hexenal, (3E)-4-(2,6,6-trimethyl-1-cyclohexen-1-yl)-3-buten-2-one, (E)-4-(2,5,6,6-tetramethyl-1-cyclohex-2-enyl)but-3-en-2-one, (E)-4-(2,6,6-trimethyl-1-cyclohex-2-enyl)but-3-en-2-one, ethyl lactate, ethyl acetate, ethyl butanoate, cis-3-hexenol, cis-3-hexenyl acetate, cis-3-hexenyl butyrate, ethyl hexanoate, ethyl isovalerate, 2-amino-methyl ester benzoic acid, 2-amino-ethyl ester benzoic acid, 2-(methylamino)-methyl ester benzoic acid, ethyl ester 2-methyl butanoic acid, Ethyl ester octanoic acid, 1-butanol-3-methyl-acetate, 4-decenal, Ethyl ester propanoic acid, 1,1-diethoxy-ethane, 2-(methylamino)-methyl ester benzoic acid, ethyl heptanoate and a combination thereof.

19. The flavor composition according to claim 10, wherein the ingredients capable of imparting a characteristic flavor note associated with alcoholic beverages note are selected from the group consisting of (−)-(1R,4E,9S)-4,11,11-trimethyl-8-methylenebicyclo[7.2.0]undec-4-ene, oakwood extract, 5-butyldihydro-4-methyl-2(3H)-furanone, chicory extract, cinnamon bark extract, clove extract, cardamon extract, marjoram extract, savory extract, gentian extract, chichonna extract, quasia amara extract, juniper extract, coriander extract, cognac extract, star anise oil, licorice extract, orange peel extract, lemon peel extract, oregano extract, thyme extract, nutmeg extract, cassia extract, rum extract, whisky extract, brandy extract, 5-allyl-1,2,3-trimethoxybenzene, ethyl ester propanoic acid, ethyl ester 2-propenoic acid, ethyl ester 2-butenoic acid, ethyl ester decanoic acid, 4-oxo-ethyl ester pentanoic acid, ethyl ester nonanoic acid, ethyl tetradecanoate, ethyl ester 2-butenoic acid, ethyl octanoate, ethyl ester dodecanoic acid and a combination thereof.
